(19) United States
(12) Patent Application Publication
(10) Pub. No.: US 2026/0368765 A1
(43) Pub. Date: Nov. 19, 2026

(54) revolutionary, disruptive, redefining, and changing modern business rules,modern macroeconomics, modern microeconomics, process of human being civilization and human being civilization’s way or the method and the method or model or the platform created to implement this method

(71) Applicant: CHUANPING HU, PITTSBURG, KS (US)

(72) Inventor: CHUANPING HU, PITTSBURG, KS (US)

(21) Appl. No.: 19/196,619

(22) Filed: May 1, 2025

(51) Int. Cl. G06Q 30/0202; G06Q 30/0201; G06Q 30/0204

(52) U.S. Cl. CPC G06Q 30/02022; G06Q 30/02012; G06Q 30/0205

(57) ABSTRACT

This method, platform or patent is planned economy under a market economy, eliminates random or blind production by factories and random or blind consumption by consumers and supply according to demand all people in the world from birth to death with the best product, goods, and service quality and the lowest prices through “non-retail” in a nontraditional sense, “no fixed cost expenses such as bank interest required by typical businesses,”
“eliminating random or blind production by manufacturers and consumption by consumers,” “thoroughly eliminating waste in the production and consumption process,” “substituting, eliminating, and thoroughly eliminating inefficient small, medium, large, and even huge enterprises in every industry for every product, commodity, or service,” “consumers being able to buy the best quality, lowest price, and best value products, commodities, or services in the world,” “saving people's time and money in consumption,” “helping the poor and reducing poverty,” “green and low-carbon,” “helping to address global climate change,” and so on. Therefore, this method, this platform, and this patent change the way people work and live, as well as the way enterprises produce products in the production process.

This patent represents a revolutionary and disruptive redefinition, reshaping, and replacement of modern economic theory, including micro and macroeconomics, since the patent changes, replaces, disrupts, redefines, and reshapes modern business rules and revolutionizes and redefines the course of human civilization and human civilization itself.

This method will establish a wave that includes Industry 4.0 or 5.0, and transform manufacturing into a service industry this method eliminates the traditional concept of primary, secondary, and tertiary industries and merge into one.

Producers under the method or patent have no advertising expenses, no sales expenses or costs, and no market expenses or costs even no financial costs, This method's revolutionary and transformative reshaping and redefining of the traditional financial industry, especially the banking sector, and human social and economic activities. This method will help and serve almost all consumers from birth to near-death around the world save time and money, optimize the way they spend their money, helps poor people and reduces the poverty rate, eliminates waste in various industries from production to consumption, therefore, is environmentally friendly and low-carbon and effectively respond to global climate change.

### SPECIFICATIONS REGARDING ADVANTAGEOUS EFFECTS, DESCRIPTION OF DRAWINGS, BEST MODE, MODE FOR INVENTION, INDUSTRIAL APPLICABILITY

### Advantageous Effects: One

1. This method (model), this platform, this patent, this platform, and this patent are planned economy and supply according to demand under a market economy.
2. Supply all products, goods, and services needed by all people in the world from birth to death.
3. With the best product, goods, and service quality and the lowest prices among similar products.
4. Supply and distribute according to demand through “non-retail” in a nontraditional sense.
5. Through artificial intelligence (based on big data, cloud computing, 5G, the Internet, the Internet of Things, etc.).
6. In a “non-retail” way that is different from the traditional concept of wholesale.
7. That is, the products go directly from production through this method, model, and platform to the hands of consumers.
8. This method can be described or expressed in digital form as follows: For

$${C}_{n}^{m} ∈ {BB}_{n}^{m} {b}_{n}^{m} + Σ ( {AI}_{i} + {I}_{i} + {P}_{i} + ⋯ ) ( with i from 1 to ∞ )$$

The formular represents the formular of global consumers and manufacturers of the platform, with n→∞ and m→∞ (n and m go to infinite),

$${C}_{n}^{m}$$

represents global consumers

$${B}_{n}^{m}$$

represents manufacturers

$${b}_{n}^{m}$$

represents products (produced by manufacturers

$${B}_{n}^{m} )$$

or Pᵢ represents products, AIᵢ represents artificial intelligence (the industry in this field) Iᵢ represents a certain industry, Pᵢ represents a certain product N→∞, M→∞ tends to infinity, representing that this method can cover almost all global consumers' needs from birth to death for products, goods, and services manufactured by manufacturers or producers

$${B}_{n}^{m} .$$

9. This method, this platform, and this patent claim a revolutionary and disruptive redefinition and reshaping of modem business rules, replacing them with claims including but not limited to “new retail enabling manufacturers and consumers to transact directly through this platform,” “planned economy under a market economy,” “on-demand production, supply, and distribution,” “no fixed cost expenses such as bank interest required by typical businesses,” “eliminating random or blind production by manufacturers and consumption by consumers,” “thoroughly eliminating waste in the production and consumption process,” “substituting, eliminating, and thoroughly eliminating inefficient small, medium, large, and even huge enterprises in every industry for every product, commodity, or service,” “consumers being able to buy the best quality, lowest price, and best value products, commodities, or services in the world,” “saving people's time and money in consumption,” “helping the poor and reducing poverty,” “green and low-carbon,” “helping to address global climate change,” and so on. Therefore, this method, this platform, and this patent change the way people work and live, as well as the way enterprises produce products in the production process.
10. This method, this platform, and this patent represent a revolutionary and disruptive redefinition, reshaping, and replacement of modern economic theory, including micro and macroeconomics, because they change, replace, disrupt, redefine, and reshape modern business rules, which constitute the core and foundation of modern economic theory to a considerable extent.
11. This method, this platform, and this patent represent a revolutionary and disruptive redefinition, reshaping, and change in the course of human civilization and human civilization itself. The revolutionary and disruptive redefinition and reshaping of modern business rules by this method, this platform, and this patent also changes the consumption behavior of people as consumers and the production behavior of enterprises in the production process. Therefore, it revolutionizes, redefines, and reshapes modern economic theory, and revolutionizes and redefines the course of human civilization and human civilization itself.

### Advantageous Effects: Two

1. This method can completely eliminate all small, medium, large, and even extra-large enterprises producing all products, commodities, and services in all industries that are inefficient, lack productivity, and outdated, such as real estate industry, commercial aircraft manufacturing, the enterprises accounted for 25% of the US GDP under the US RFC's DPC during World War II, and power plants that buy coal with cash due to coal power shortages today.
2. This method can also eliminate random or blind production by factories and random or blind consumption by consumers.
3. This method can eradicate the massive and appalling waste generated in various industries during production and consumption due to blind production and consumption. For example, a research report on China's service industry by Alibaba Research Institute pointed out that the clothing industry in China generates waste of 400 billion yuan in the production process and 400 billion to 800 billion yuan in the consumption process each year due to blind and random production by manufacturers and blind and random consumption by consumers.
4. This method will establish a wave that includes Industry 4.0 or 5.0, namely industrial artificial intelligence.
5. This method will transform manufacturing into a service industry through the application of platform-based products using MMP_{ALL+S+SS+M} and AI artificial intelligence. Where MMP_{ALL+S+SS+M}=MMP_{ALL}+MMP_{S}+MMP_{SS}+MMP_{M}, where MMP stands for “My Model and Platform,” and My refers to Dr. Chuanping Hu.
6. Therefore, this method eliminates the traditional concept of primary, secondary, and tertiary industries, and the primary, secondary, and tertiary industries (where the primary industry refers to agriculture, forestry, animal husbandry, and fisheries (excluding agricultural, forestry, animal husbandry, and fishery services). The secondary industry refers to mining (excluding mining support activities), manufacturing (excluding metal products, machinery and equipment repair and maintenance), electricity, heat, gas, and water production and supply industries, and construction. The tertiary industry refers to the service industry, which includes all industries other than the primary and secondary industries) are integrated under this method and the MMP_{ALL+S+SS+M} platform established to achieve this method.
7. This method (1) applies to when consumers

$${C}_{n}^{m}$$

and producer

$${B}_{n}^{m}$$

are from different countries or regions, such as consumers

$${C}_{n}^{m}$$

and manufacturers

$${B}_{n}^{m}$$

in different countries, like

$${B}_{n}^{m}$$

### in China, (2)

$${C}_{n}^{m}$$

in other countries, it creates a dual cycle of domestic and international economies, and when

$${C}_{n}^{m} {B}_{n}^{m}$$

are within the same country, like in China, it creates a large domestic cycle, and (3) it involves supply-side structural reform when using more advanced and better scientific and technological means, such as artificial intelligence, to change production or satisfy constantly changing demand.
(4) This method, and the platform MMP_{ALL+S+SS+M} created to implement it,

$${C}_{n}^{m} ∈ {BB}_{n}^{m} {b}_{n}^{m} + Σ ( {AI}_{i} + {I}_{i} + {P}_{i} + ⋯ ) ( with i from 1 to ∞ )$$

The formular represents the formular of global consumers and manufacturers of the platform, with n→∞ and m→∞ (n and m go to infinite),

$${C}_{n}^{m}$$

represents global consumers

$${B}_{n}^{m}$$

represents manufacturers

$${b}_{n}^{m}$$

represents products (produced by manufacturers

$${B}_{n}^{m} )$$

or Pᵢ represents products, AIᵢ represents artificial intelligence (the industry in this field) Iᵢ represents a certain industry, Pᵢ represents a certain product N→∞, M→∞ tends to infinity, representing that this method can cover almost all global consumers' needs from birth to death for products, goods, and services manufactured by manufacturers or producers

$${B}_{n}^{m} ,$$

when N and M are very large, especially as N→∞ and M→∞, is equivalent to the RFC company of the United States during World War II, which accounted for 25% of the US GDP at that time. The platform and the consumers

$${C}_{n}^{m}$$

and manufacturers

$${B}_{n}^{m}$$

on the platform together constitute the output value equivalent to the GDP of a country or region.
8. Under this method, the enterprises and manufacturers: (1) have no advertising expenses, no sales expenses or costs, and no market expenses or costs; (2) even for some or most of the companies under the platform, there are no financial costs, that is, no loan interest costs (for companies belonging to the platform that implements this method); (3) especially for companies and manufacturers belonging to the platform; (4) because there are no above-mentioned costs that non-platforms must bear, such as advertising, marketing, sales, etc.; (5) their products, goods, and services will undoubtedly be more competitive, with better and cheaper prices; (6) because the fixed costs mentioned above must be transferred to the consumers who will pay the bill; (7) because financial support and economic activity usually account for 70% or more of the support for manufacturers.
9. Therefore, this method's revolutionary and transformative reshaping and redefining of the traditional financial industry, especially the banking sector, and the contribution of this method, this platform, and this patent to human social and economic activities, account for more than 70%,
10. The artificial intelligence and other technologies adopted by this platform, which was created to implement this method, will (1) revolutionize and redefine the vertical fields of the financial industry, banks, retail, corporate operations, investments, etc.; (2) integrate the physical world and the digital world in the financial industry under this method in the future; (3) improve efficiency, safety, and customer experience.
11. In fact, the financial institutions and banks under the platform MMP_{ALL+S+SS+M} under this method, or the financial institutions and banks closely cooperating with the platform, will achieve the ultimate efficiency, safety, and customer experience, far beyond what other financial institutions and banks in the industry can compare or compete with.
12. In fact, under this method, the financial institutions and banks generated by the platform MMP_{ALL+S+SS+M} will (1) eliminate almost all other financial institutions and banks; (2) be more thorough in their impact and change to the financial and banking industry than the so-called financial technology or fintech of Ant Group, Tencent's Wealth Management Group, and their payment tools such as Alipay or WeChat Pay, in all the businesses carried out by Ant Group, Tenpay (financial tools, functions, and attributes) in payment links, small and micro loans, Yu'ebao, etc.
13. The financial institutions and banks under the platform or closely cooperating with the platform under this method will revolutionize, reshape, and redefine the financial industry, including banks and financial institutions, in a more complete and earth-shattering way, presenting a completely different form and ecology from the traditional meaning of the financial industry, demonstrating different forms and ecologies of business civilization
14. Under this method, the impact and influence of financial technologies such as artificial intelligence that collaborate closely with or operate on the platform MMP_{ALL+S+SS+M}, which is implemented in this method, will be enormous, revolutionary, and disruptive to the banking industry. This method initially applies to payments and retail, or what is soon called “non-retail,” such as corporate loans, management without loans, and wealth management. In fact, people, consumers, or members under this method and this platform, and this patent, are more willing to use their disposable income on daily necessities such as clothing, food, housing, transportation, medical care, education, elderly care, childcare, etc., with the best global quality, lowest prices, and best value, and for investment, including housing, on this platform. As a result, manufacturers and companies under this method, platform, and patent usually do not need to borrow from banks for production, advertising, sales, marketing, and distribution because the full payment for the goods received in advance through the MMP is enough to cover these expenditures. It is conceivable that people will no longer deposit money in banks, and manufacturers and companies will no longer borrow from banks. Therefore, the lifeline and pillar business of banks and the financial industry to earn interest spreads on deposits and loans will be significantly negatively impacted, making it difficult for them to survive. Banks and financial companies under this method, platform, and patent will find it difficult to survive and may even be eliminated by banks and financial companies operating on the MMP platform.
15. This method will help and serve almost all consumers from birth to near-death around the world on the platform MMP_{ALL+S+SS+M}, which is established to implement this method.
(1) Save money.
(2) Optimize the way they spend their money.
(3) Shop or receive products from the platform after it collects information, including demand information, through artificial intelligence, and pushes the products.
(4) Buy the products with the best quality and the cheapest price (compared to similar products worldwide).
(5) Therefore, the consumers on this platform can spend their money most efficiently.
(6) In some cases, the money spent on this platform is also the best investment, with the best investment return.
(7) For example, consumers on the platform can participate in collective fundraising to buy houses at a price that is 25%-40% cheaper than the market price under the platform's organization.
(8) This is because the platform's organization does not have traditional real estate companies' interest costs incurred by borrowing from banks. Additionally, there are no costs associated with sales, marketing, or advertising for vacant properties.
(9) Therefore, compared to traditional real estate companies, people on the MMP_{ALL+S+SS+M} platform can save at least 25%-40% of the above-mentioned fixed costs when purchasing houses.
(10) In other words, people on this platform can buy houses of the same quality and value at a price that is lower than the market price or 25%-40% cheaper.
(11) Thus, consumers on the MMP_{ALL+S+SS+M} platform established by this method can immediately obtain a 25%-40% return on investment while making purchases.
(12) Buying a house is both for living and investing, and it has both usage and investment attributes.
16. This method saves people a lot of time, especially for people on the platform MMP_{ALL+S+SS+M}, or members of the platform, for what to buy, what is cost-effective, cheap, and of good quality. Furthermore, based on the available consumer spending of each consumer, this method and the platform MMP_{ALL+S+SS+M}, have made the best decisions for consumers based on artificial intelligence, including but not limited to algorithms, which determine what kind of consumers need to buy what kind of products at what stage. Additionally, the platform offers the cheapest and highest quality products in the same category globally, which are produced on demand and distributed to platform members. Especially since the platform has its own manufacturers, it can produce, supply, and distribute (after payment) products to members and consumers without the cost of advertising, sales, marketing, circulation, bank loan interest, etc.
17. This method helps poor people and reduces the poverty rate, as artificial intelligence and other platforms under MMP_{ALL+S+SS+M} can be used under the current conditions of poor people or under their disposable income. Even government subsidies or safety nets, such as Medicare and Medicaid for poor and elderly people in Western countries like the United States, and China's low-income support for poor people, can be used. Furthermore, this method and platform implementation can help poor people or those who have lifted themselves out of poverty, such as the new rural cooperative medical insurance for rural populations, and urban medical care for urban populations. “Because this method and the implementation platform MMP_{ALL+S+SS+M} can transform the limited income of poor people, including the low-income guarantee, into the satisfaction of the needs that are most needed by the poor under optimization. In other words, this method and this platform can use artificial intelligence to transform the limited income of poor people into products and commodities that best meet their needs through their own enterprise and business.”
18. This method maximizes the elimination of waste in various industries from production to circulation to consumption. For example, in the clothing industry alone, after the complete adoption and implementation of this method and platform in China, 800 billion yuan of waste can be eliminated in the production process and 400 billion yuan in the circulation and consumption process, totaling 1.2 trillion yuan of consumption waste. This does not include other industries, including but not limited to the financial, banking, and medical industries. Therefore, this method and platform are environmentally friendly and low-carbon.
19. Thus, this method and the MMP_{ALL+S+SS+M} platform can effectively respond to global climate change.
20. All global consumers or members

$${C}_{n}^{m}$$

under this method and the MMP_{ALL+S+SS+M} platform.

$${C}_{n}^{m} ∈ {BB}_{n}^{m} {b}_{n}^{m} + \sum ( {AI}_{i} + {I}_{i} + {P}_{i} + … ) ( with i from 1 to ∞ )$$

The formular represents the formular of global consumers and manufacturers of the platform, with n→∞ and m→∞ (n and m go to infinite),

$${C}_{n}^{m}$$

represents global consumers

$${B}_{n}^{m}$$

represents manufacturers

$${b}_{n}^{m}$$

represents products (produced by manufacturers

$${B}_{n}^{m} )$$

or Pᵢ represents products, AIᵢ represents artificial intelligence (the industry in this field) Iᵢ represents a certain industry, Pᵢ represents a certain product N→∞, M→∞ tends to infinity, representing that this method can cover almost all global consumers' needs from birth to death for products, goods, and services manufactured by manufacturers or producers

$${B}_{n}^{m} .$$

With N→∞ and M→∞, (1) “non-retail” does not refer to the traditional business concept of “wholesale.” (2) Instead, under this method and platform, manufacturers MMP_{ALL} and producers

$${B}_{n}^{m}$$

under MMP_{S}, MMP_{SS}, MMP_{M}, or those with close cooperation with the platform, engage in direct transactions with consumers

$${C}_{n}^{m}$$

through the platform to form a “non-retail” buying and selling behavior.
21. The platform adopts various methods, including but not limited to short video platforms, social software, and e-commerce platforms.
(1) MMP_{ALL+S+SS+M} is not only a traditional e-commerce platform, (2) but also a traditional manufacturing platform. (3) It collects demand and wallet information, (4) and enables consumers to buy all kinds of products and goods with the best global price-performance ratio and the lowest price under the “non-retail” model. (5) Manufacturers, merchants, and enterprises under MMP_{ALL}, MMP_{S}, MMP_{SS} and MMPM have an unbeatable advantage compared to those who are not on the platform or do not cooperate with the platform. As a result, they can ultimately eliminate and replace non-platform manufacturers and enterprises.
(6). Under this method and platform, manufacturers, merchants, and enterprises produce, supply, and distribute (with payment) according to demand. They do not have to bear the rigid costs that traditional companies, manufacturers, and merchants must bear, including but not limited to advertising, consumption, and market costs, and even loan interest. Moreover, they do not produce or consume blindly and randomly, resulting in no waste.
(7) For all products in all industries, such as the research released by Alibaba Research Institute on the Chinese clothing industry, there is a waste of 800 billion to 1.2 trillion yuan each year in the production and consumption processes, with 400 billion in the production process and 400 billion to 800 billion in the consumption process.
(8) Typically, these wasted costs are passed on to consumers to pay.
22. The method and platform for all

$${B}_{n}^{m} and {C}_{n}^{m}$$

under MMP_{ALL+S+SS+M}=MMP_{ALL}+MMP_{S}+MMP_{SS}+MMP_{M}. For

$${C}_{n}^{m} ∈ {BB}_{n}^{m} {b}_{n}^{m} + \sum ( {AI}_{i} + {I}_{i} + {P}_{i} + … ) ( with i from 1 to ∞ )$$

The formular represents the formular of global consumers and manufacturers of the platform, with n→∞ and m→∞ (n and m go to infinite),

$${C}_{n}^{m}$$

represents global consumers

$${B}_{n}^{m}$$

represents manufacturers

$${b}_{n}^{m}$$

represents products (produced by manufacturers

$${B}_{n}^{m} )$$

or Pᵢ represents products, AIᵢ represents artificial intelligence (the industry in this field) Iᵢ represents a certain industry, Pᵢ represents a certain product N→∞, M→∞ tends to infinity, representing that this method can cover almost all global consumers' needs from birth to death for products, goods, and services manufactured by manufacturers or producers

$${B}_{n}^{m} ,$$

### for N→∞ M→∞ or N>No, N<No, M>Mo, M<Mo.

This method and platform deal with the supply and demand of all kinds of necessities, goods, products, and services for various age groups from birth to the end of life around the world, including food, clothing, shelter, transportation, and more, with the best quality and lowest price provided by manufacturers and enterprises driven by artificial intelligence as the core, and supplied and distributed according to the best cost-effectiveness on demand.

All kinds of needs from around the world, from birth to approaching death, for various products, goods, or services related to clothing, food, shelter, and transportation, are met through this platform by providing the best quality and lowest price, i.e., the best value for money, through production, supply, and distribution.

The best quality is mainly implemented and achieved through manufacturers and businesses powered by artificial intelligence at the core of this platform, while the lowest price is mainly achieved through consumers gathered on this platform who exchange quantity for price, which is almost equivalent to wholesale, but is actually a new type of “non-retail” in the sense that they purchase a particular product or goods in bulk and negotiate with e-commerce or life platforms for lower prices, and this platform enables them to buy the products or goods with the best quality and lowest price, i.e., the best value for money.

This platform gathers consumers to purchase the same product in large quantities and buys the best quality and lowest-priced products. The products or goods are either produced by the MMP_{ALL+S+SS+M}=MMP_{ALL}+MMP_{S}+MMP_{SS}+MMP_{M} on this platform itself, according to the needs, or are orders for customization, OEM, or OEM from the MMP_{SS} or MMP_{M} gathered on this platform and implemented, realized, and completed by the production, manufacturing, and supply according to the needs by the MMP_{ALL} or MMP_{S} or MMP_{SS} or MMP_{M} on this platform.

### DESCRIPTION OF DRAWINGS

This method and the platform MMP_{ALL+S+SS+M} created for implementing this method in reality. For

$${C}_{n}^{m} ∈ {BB}_{n}^{m} {b}_{n}^{m} + \sum ( {AI}_{i} + {I}_{i} + {P}_{i} + … ) ( with i from 1 to ∞ )$$

The formular represents the formular of global consumers and manufacturers of the platform, with n→∞ and m→∞ (n and m go to infinite),

$${C}_{n}^{m}$$

represents global consumers

$${B}_{n}^{m}$$

represents manufacturers

$${b}_{n}^{m}$$

represents products (produced by manufacturers

$${B}_{n}^{m} )$$

or Pᵢ represents products, AIᵢ represents artificial intelligence (the industry in this field) Iᵢ represents a certain industry, Pᵢ represents a certain product N→∞, M→∞ tends to infinity, representing that this method can cover almost all global consumers' needs from birth to death for products, goods, and services manufactured by manufacturers or producers

$${B}_{n}^{m} .$$

### N→∞, M→∞

The working principle and implementation process of this patent. An illustrated diagram of the composition of the working principle and implementation process of this method or platform, which includes MMP_{ALL+S+SS+M}=MMP_{ALL}+MMP_{S}+MMP_{SS}+MMP_{M}, that is, MMP_{ALL+S+SS+M} consists of or is composed of four sub-platforms: MMP_{ALL}, MMP_{S}, MMP_{SS}, and MMP_{M}.

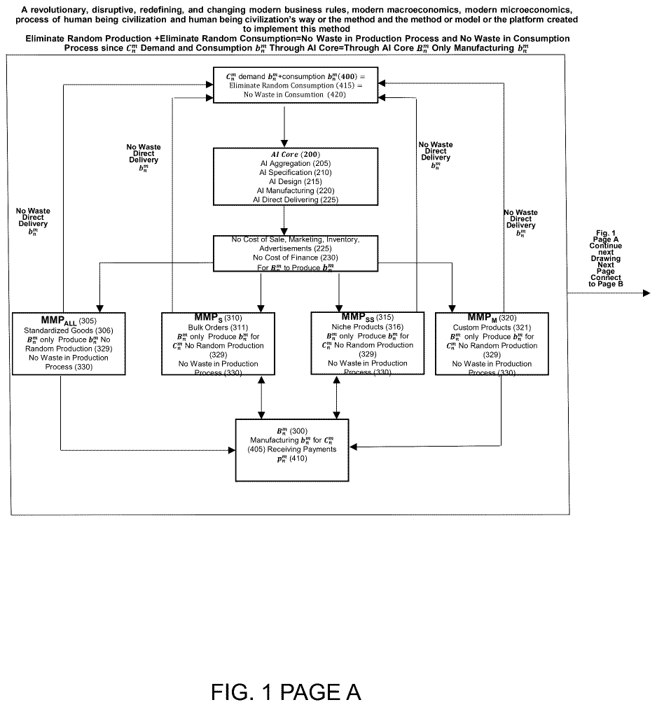

Please see FIG. 1 in the Chart (Drawing).

FIG. 1 represents the working principle and implementation process of this patent, the illustrated figure of the composition of the working principle and implementation process of this method or platform, which includes MMP_{ALL+S+SS+M}=MMP_{ALL}+MMP_{S}+MMP_{SS}+MMP_{M}. That is, MMP_{ALL+S+SS+M} consists of or is composed of four sub-platforms: MMP_{ALL}, MMP_{S}, MMP_{SS}, and MMP_{M}.
(1) 1. Where

$${B}_{n}^{m}$$

under MMP_{ALL}, the ARM manufactured under MMP_{ALL} is one of the two important components of this platform, which is manufactured under the main drive of artificial intelligence AI, and is the best quality product, commodity or service

$${b}_{n}^{m}$$

among similar products in a country or region globally. 2. The best quality product, commodity or service among similar products is produced on demand and supplied to its members or consumers through the e-commerce platform's another ARM. 3. The platform collects people's needs from birth to death worldwide through artificial intelligence. 4. And through artificial intelligence, it is promoted and customized as C2B, forming a large-scale volume procurement. 5. This makes the price the lowest among similar products through volume discounts.
(2) MMP_{S}=MMP smell 1. It is composed of manufacturers and enterprises that are not manufactured by the platform but have close cooperation with the platform. They are guided by artificial intelligence on this platform and act as OEMs for the platform, customized and sold through the platform to the platform's consumers or members.

The platform AI ensures that the quality of the product is the best among similar products and is purchased in large quantities through the platform's targeted bidding. N>No is a large level of quantity in a particular country produced and supplied by manufacturers and enterprises, which is then distributed (after payment) through the platform at the lowest price among similar products.
(3) MMP_{SS}=MMPsmall small. Except for N<No, it is basically the same as MMP_{S}. The platform can still guarantee that consumers can purchase the best quality products at the lowest price among similar products in a country or region globally, even if the quantity purchased through the platform has not reached a significant level. The price is still guaranteed to be the lowest because the enterprises and manufacturers under MMP_{SS} do not have fixed costs, advertising expenses, sales and marketing costs, and even bank loan interest costs (see Chapter 1 of this method, platform, and patent, and the relevant parts of Chapter 3 of the patent claim).
(4) MMP_{M}=Micros is a cooperation partner of the platform and accepts platform AI guidance to produce, including but not limited to OEMs for the platform, customized, reverse bidding, and sold through the platform to the platform's consumers or members. The best quality product is produced jointly with the platform AI, and the price is the lowest because it does not have the fixed costs, advertising expenses, sales, marketing costs, and even bank loan interest costs that general enterprises must have.

### BEST MODE

Example 1 in the real estate industry shows that the method and platform are feasible, workable, and can be implemented and realized, as it is a form of “non-retail” planned economy under market economics that supplies according to demand and meets the needs of consumers. This example also perfectly explains the patent claim that, under this method and platform, companies and manufacturers do not have to pay advertising, sales, or marketing costs, nor do they have to pay interest on bank loans. Consumers do not have to keep their money in the bank for a low interest rate, but can use it for collective funding and purchase products at a 25% to 40% lower price than the market price.

Moreover, companies under this method, platform, and patent do not need to borrow from banks and pay interest costs. The funds raised by consumers or members under this method, platform, and patent are sufficient to cover all the costs or funds required to build commercial housing.

Therefore, it is evident that this method, platform, and patent not only benefit consumers and members, enabling them to buy the world's best quality and lowest-priced products (commercial housing) with the highest cost-effectiveness on the platform, but also benefit manufacturers and companies under the platform, allowing them to win in the competition for similar products and eventually eliminate their competitors.

It is said that “raising funds to build houses” does not require traditional expenses such as advertising, marketing, sales, and bank loan interest because all the funds have been advanced, and the houses have been pre-ordered and purchased by all the fundraisers before the land was acquired. Therefore, the cost of the houses built with this fundraising method is 30%-40% lower than that of the commercial housing in the same city.

This also confirms and proves the enormous and revolutionary, disruptive, and transformative impact that this method, platform, and patent have on the banking and financial industries.

Personal consumers will no longer deposit their money into banks, and manufacturers and companies no longer need to borrow from banks.

As a result, the most important and essential business of the banking industry, earning the interest difference between deposits and loans, will suffer a huge impact and may even cease to exist.

It can be imagined that this example fully illustrates, confirms, and proves the method, platform, and patent, even in terms of figures.

It not only has a huge revolutionary, disruptive impact and change on consumers of all skin colors, populations, and age groups worldwide but also on manufacturers and companies producing various products, goods, and services in all industries worldwide. Similarly, it has a huge revolutionary, disruptive, alternative, and eliminative impact and change on the global banking and financial industries, which may be overturned, eliminated, and replaced by this platform, method, and patent, ultimately making them no longer exist or changing their form of existence.

Moreover, since the banking and financial industries contribute more than 70% to the modern social and economic activities, 18. this method, platform, and patent will overturn, eliminate, redefine, reshape, and replace the banking and financial industries, making them no longer exist or changing their form of existence in a different way from the modern banking and financial industries.

Therefore, if the significance or contribution of this method, platform, and patent to modern social and economic activities exceeds 70%, it should not be underestimated.

The significance of the invention of this method, platform, and patent by HU Chuanping lies in its revolutionary, disruptive, and redefining role in modern and contemporary commercial rules, the process of human civilization, including but not limited to the above-mentioned banking and financial industries.

Therefore, emphasizing the great significance of the invention and creation of this method, platform, and patent is not excessive.

Its milestone role in modern and contemporary commerce, economic activities, economic theories, and the process of human civilization will become increasingly prominent.

Successful Example of the MMP_{ALL+S+SS+M}=MMP_{ALL}+MMP_{S}+MMP_{SS}+MMP_{M}'S patent

This method, this platform, and this patent's successful examples in the past can indirectly confirm and demonstrate the feasibility of this patent and its claims.

Example 2: The Roosevelt New Deal from 1933 to 1985, which was implemented during the later stages of the Great Depression in the United States, was to some extent planned economics under market economics. Under this plan, banks were assisted and allocated, and factories and enterprises were directed to produce specific products and goods, successfully leading the United States out of the Great Depression and restoring its economy before, during, and after World War II, making it a superpower after the war. Roosevelt was therefore regarded as one of America's four greatest presidents. This example proves and validates an important claim of this patent, method, and platform, which is that planned economics under market economics works and is feasible.

Example 3: During World War II, the Reconstruction Finance Corporation (RFC), a public-private cooperative reconstruction finance company established by the White House and Congress in 1929 to revive the economy after the stock market crash, established the Defense Plant Corporation (DPC), which accounted for 25% of the US GDP near the end of WWII. The DPC provided loans and tax incentives for tank, aircraft, and other weapons manufacturing and provided products and services to allied countries. With the help of this defense plant company, US manufacturing capacity increased by 50% by the end of World War II, and by 1940, the company's output accounted for 25% of US GDP. The company reshaped the US aviation and electronics industries, making them one of the largest sectors in the US economy. This example proves, confirms, and validates an important claim of this patent, method, and platform from one perspective, which is that supply according to demand is safe, feasible, and effective.

Example 4: The centralized procurement of drugs and medical consumables, such as stents, by the Chinese National Medical Insurance Administration, resulted in an average price drop of more than 90% from an average price of 13,000 yuan to 700 yuan per unit. This example proves, confirms, and illustrates from one perspective that the method and platform of exchanging quantity for price is feasible. This example was only achieved in China through the power of the National Medical Insurance Administration, which represents public hospitals and patients in China, and was not specifically aimed at any particular patient or consumer. However, this patent, method, and platform are not only aimed at specific consumer groups but also specific consumers. This makes the impact of the quantity-for-price exchange even greater, and under this patent, method, and platform or patent application, consumers or consumer groups may not only include Chinese consumers but also consumers from other countries. Thus, the impact of the quantity-for-price exchange is even greater, and consumers can benefit from this method, platform, and patent application.

Examples of success related to this method, this platform, and this patent:

Example 5: Prior to the end of 2019 during the COVID-19 pandemic, especially when demand for commercial airlines was high, global airlines or aircraft leasing companies needed to pay cash, even full cash, to Boeing or Airbus, the global duopoly, to order planes that would only be delivered three to five years later. A similar situation exists for some scarce car models such as Ferrari or Lamborghini, where consumers must pay the full price months in advance before receiving the car.

This example illustrates that for global scarce or scarce commodities, consumers are willing and have to pay the full price in advance and wait for several months or even years to receive the physical products or commodities.

This example demonstrates that this method, this platform, and this patent can ensure that consumers can purchase the highest quality and lowest priced products or goods globally, from manufacturers or companies. Consumers are willing and fully able to pay the full amount in advance before receiving the physical products or goods. As a result, manufacturers or companies such as Boeing or Airbus can use consumers' money to produce and supply (after payment), thereby significantly saving interest costs of borrowing from banks. For some industries and goods, such as the example of “crowdfunding to build houses,” enterprises no longer need to borrow from banks. The full payment made by the crowdfunding buyers or homeowners in advance covers all costs, including land acquisition, construction, decoration, and landscaping, so there are no interest payments for bank loans, nor are there any rigid expenses for advertising, sales, marketing, vacancy, etc. Therefore, in the end, the consumers who “crowdfund to build houses” can buy houses at 25%-40% below market prices (the saved 25%-40% is actually saved from interest on bank loans, advertising expenses, sales costs, marketing expenses, etc.). Of course, “crowdfunding to build houses” must be carried out within the legal and non-violating limits.

This method and the implementation platform MMP_{ALL+S+SS+M} of this patent are different from traditional e-commerce platforms such as Amazon, Tmall, Taobao, Jingdong, or PDD, as well as modern e-commerce platforms such as Douyin, Kuaishou, and Xiaohongshu, and even WeChat's mini-program. Although Amazon dominates the US market, all US companies' e-commerce sales through their own e-commerce platforms account for more than 60% of the total e-commerce sales. WeChat's mini-program was only introduced as a response to this. In 2020, its GMV may have reached 1.7 trillion yuan.

This platform is not only a new type of e-commerce platform powered by AI but also an unprecedented manufacturing platform composed of N manufacturing companies where N→∞, meaning N tends to infinity.

It combines MMP_{ALL}'s own manufacturing, MMP_{S}'s close cooperation with the platform for large and medium-sized companies where N>No, MMP_{SS} 's close cooperation with small and medium-sized enterprises where N<No (see the cooperation method mentioned above), and MMP_{Micros}, the mini-program on this platform (similar to WeChat's mini-program), into a single platform. This platform is unique in that it is a manufacturing platform that includes manufacturers, including the platform's own manufacturing, and is also a new type of e-commerce platform for traditional manufacturing companies.

### Please see FIG. 1 in the Chart (Drawing).

FIG. 1 represents the working principle and implementation process of this patent, the illustrated figure of the composition of the working principle and implementation process of this method or platform, which includes MMP_{ALL+S+SS+M}=MMP_{ALL}+MMP_{S}+MMP_{SS}+MMP_{M}. That is, MMP_{ALL+S+SS+M} consists of or is composed of four sub-platforms: MMP_{ALL}, MMP_{S}, MMP_{SS}, and MMP_{M}.
(7) While Amazon, Ali, JD, and PDD basically do not have manufacturers or customizations, contract manufacturing, or package sales of ARM under AI guidance on this platform and patent.

Under the concept of “retail”, which was created and prevailed during the early days of modern business and human civilization when people did not have good ways or tools or channels or technologies to obtain necessary information for products, goods, and services or information for productions and consumption, there are no more “so-called” traditional sales to consumers. For example, manufacturers usually do not know how many products to make to satisfy the demands of consumers, let alone also face competition from competitors. Therefore, most of the time, they only manufacture products randomly or according to studies or investigations or projections, which inevitably leads to waste in production and consumption, such as the clothing industry in China, which generates an annual waste of 1.2 trillion yuan, and costs of advertisement, sales, marketing, as well as the cost of interests of banking loans.

However, nowadays, with the discovery and development of 5G, industrial internet, e-commerce, digitalization of industry or industrialization of digital, AI, big data, cloud computation, DNA, MRNA or RUA, biotech, quantum computing using photons and computational biology, especially with the method, platform, and patent of MMP_{+S+SS+M}, which revolutionizes, reshapes, and redefines the modern business rules and civilization, traditional “retail” sales will be eliminated.

### MODE FOR INVENTION

The Business Model of MMP_{ALL+S+SS+M} and

$${C}_{n}^{m} ∈ {BB}_{n}^{m} {b}_{n}^{m} + \sum ( {AI}_{i} + {I}_{i} + {P}_{i} + … ) ( with i from 1 to ∞ )$$

The formular represents the formular of global consumers and manufacturers of the platform, with n→∞ and m→∞ (n and m go to infinite),

$${C}_{n}^{m}$$

represents global consumers

$${B}_{n}^{m}$$

represents manufacturers

$${b}_{n}^{m}$$

represents products (produced by manufacturers

$${B}_{n}^{m} )$$

or Pᵢ represents products, AIᵢ represents artificial intelligence (the industry in this field) Iᵢ represents a certain industry, Pᵢ represents a certain product N→∞, M→∞ tends to infinity, representing that this method can cover almost all global consumers' needs from birth to death for products, goods, and services manufactured by manufacturers or producers

$${B}_{n}^{m} ,$$

will revolutionist, reshape, redefine modern business rules and human being's process of civilization
(−) MMP_{ALL} consists of
1. N+1 acquisitions
2. M+1 bootstraps
3. O+1 joint adventures

In turn consists of the followings:
1. “Non-retail”
2. “Self-made” manufacturing
3. Manufacturing the best products and goods with the help of artificial intelligence.
4.

$${B}_{n}^{m}$$

On-demand production, supply, and distribution

$${C}_{n}^{m}$$

for customization, ordering, contract manufacturing, and consignment sales.

$${C}_{n}^{m} ∈ {BB}_{n}^{m} {b}_{n}^{m} + \sum ( {AI}_{i} + {I}_{i} + {P}_{i} + … ) ( with i from 1 to ∞ )$$

The formular represents the formular of global consumers and manufacturers of the platform, with n→∞ and m→∞ (n and m go to infinite),

$${C}_{n}^{m}$$

represents global consumers

$${B}_{n}^{m}$$

represents manufacturers

$${b}_{n}^{m}$$

represents products (produced by manufacturers

$${B}_{n}^{m} )$$

or Pᵢ represents products, AIᵢ represents artificial intelligence (the industry in this field) Iᵢ represents a certain industry, Pᵢ represents a certain product N→∞, M→∞ tends to infinity, representing that this method can cover almost all global consumers' needs from birth to death for products, goods, and services manufactured by manufacturers or producers

$${B}_{n}^{m} ,$$

### for N→∞ M→∞ or N>No, N<No, M>Mo, M<Mo.

MMP_{ALL} is the best brand for all kinds of products and goods from various industries around the world on this platform using this method.
(II) The ALL brand is implemented in the following three parts:
   1. Acquisition of the best N+1 global brands.
   2. The best quality and lowest price products and goods created by this platform itself (through AI and other technologies) in various industries with different technological levels, including high-tech and low-tech brands.
   3. Products and goods produced through cooperation with the best global platforms.
(III)
MMPs consists of the following:
S stands for small for N>No or large
   1. “Non-retail” to reverse bidding.
   2. Customization+OEM+consignment production according to demand, supply, and distribution (after payment), eliminating blind random production.
   3. AI guidance provided by this platform.
   4. When the quantity of products N is at least M, manufacturers, merchants, and companies on this platform are free from financial costs such as advertising, marketing, and bank loan interest, reducing the pressure of operating costs.
   5. All MMPs open virtual flagship stores on the platform, and AI is used to implement reverse bidding for bulk purchases (similar to China's National Medical Security Bureau's bulk purchase from global pharmaceutical companies). The platform uses AI to operate.
   6. The system pushes the products produced by manufacturers and companies.
(IV)
MMP_{SS} consists of the following:
SS stands for small small for N<No
   1.
   2.
   3.
   4. When the quantity of products N is less than No.
   5.
   6. The rest of the MMP_{SS} are the same as 1.2.3.5.6 in MMPs.
(V) MMP_{M} stands for MMP micros consists of the followings:
   1. Similar to WeChat mini-programs, this method and platform help small and medium-sized enterprises sell products. The platform system and mini programs, with the assistance of AI, help various small and medium sized enterprises open flagship stores.
   2. Bulk purchase, AI is used to implement reverse bidding, completed by the platform using AI.
   3. Compared with Tmall, Taobao, Jingdong, or PDD, manufacturers and merchants operate their own flagship stores on this platform, which includes various small and medium sized enterprises' flagship stores in MMP micros. (1) The platform uses AI to open stores. (2) The operation, including selling products and goods through reverse bidding, is entirely implemented by the platform. (3) This greatly reduces the operating and marketing costs of various small and medium sized enterprises in MMPM. (4) In addition to being able to receive orders for customization, OEM, and consignment through reverse bidding and other methods on this platform, small and medium-sized enterprises under this platform can also obtain consumers under the platform.

The method and platform for all

$${B}_{n}^{m} and {C}_{n}^{m}$$

under MMP_{ALL+S+SS+M} For

$${C}_{n}^{m} ∈ B {B}_{n}^{m} {b}_{n}^{m} + \sum ( {AI}_{i} + {I}_{i} + {P}_{i} + ⋯ ) ( with i from 1 to ∞ )$$

The formular represents the formular of global consumers and manufacturers of the platform, with n→∞ and m→∞ (n and m go to infinite),

$${C}_{n}^{m}$$

represents global consumers

$${B}_{n}^{m}$$

represents manufacturers

$${b}_{n}^{m}$$

represents products (produced by manufacturers

$${B}_{n}^{m} )$$

or Pᵢ represents products, AIᵢ represents artificial intelligence (the industry in this field) Iᵢ represents a certain industry, Pᵢ represents a certain product N→∞, M→∞ to infinity, representing that this method can cover almost all global consumers' needs from birth to death for products, goods, and services manufactured by manufacturers or producers

$${B}_{n}^{m} ,$$

### for N→∞ M→∞ or N>No, N<No, M>Mo, M<Mo.

This method and platform deal with the supply and demand of all kinds of necessities, goods, products, and services for various age groups from birth to the end of life around the world, including food, clothing, shelter, transportation, and more, with the best quality and lowest price provided by manufacturers and enterprises driven by artificial intelligence as the core, and supplied and distributed according to the best cost-effectiveness on demand.

All kinds of needs from around the world, from birth to approaching death, for various products, goods, or services related to clothing, food, shelter, and transportation, are met through this platform by providing the best quality and lowest price, i.e., the best value for money, through production, supply, and distribution.

The best quality is mainly implemented and achieved through manufacturers and businesses powered by artificial intelligence at the core of this platform, while the lowest price is mainly achieved through consumers gathered on this platform who exchange quantity for price, which is almost equivalent to wholesale, but is actually a new type of “non-retail” in the sense that they purchase a particular product or goods in bulk and negotiate with e-commerce or life platforms for lower prices, and this platform enables them to buy the products or goods with the best quality and lowest price, i.e., the best value for money.

This platform gathers consumers to purchase the same product in large quantities and buys the best quality and lowest-priced products. The products or goods are either produced by the MMP_{ALL+S+SS+M}=MMP_{ALL}+MMP_{S}+MMP_{SS}+MMP_{M} on this platform itself, according to the needs, or are orders for customization, OEM, or OEM from the MMP_{SS} or MMPM gathered on this platform and implemented, realized, and completed by the production, manufacturing, and supply according to the needs by the MMP_{ALL} or MMP_{S} or MMP_{SS} or MMPM on this platform.

This method and platform can be mathematically proven to revolutionize, disrupt, reshape, and redefine modern business rules, the process of human civilization, and human civilization itself.

For example, this method and platform can eliminate or at least effectively reduce the waste of RMB 800 billion to 1.2 trillion in China's clothing industry each year by producing, supplying, and distributing clothing on demand in all Chinese clothing factories and by consuming clothing according to demand by all Chinese people. This example itself mathematically proves that this method and platform, or this patent claim, is superior to existing business rules and revolutionizes, disrupts, reshapes, and redefines modern business rules, as well as modern economics, whether micro or macro, the process of human civilization and human civilization.

### INDUSTRIAL APPLICABILITY

Industrial Applicability consists of MMP_{ALL+S+SS+M}=MMP_{ALL}+MMP_{S}+MMP_{SS}+MMP_{M} in Mode for Invention, Best Mode, Description of Drawings. Advantageous Effects, Technical Solution etc.

### BRIEF DESCRIPTION OF THE DRAWINGS

FIG. 1 PAGE A and FIG. 1 PAGE B illustrate Eliminate Random Production+Eliminate Random Consumption=No Waste in Production Process and No Waste in Consumption Process since

$${C}_{n}^{m}$$

### Demand and Consumption

$${b}_{n}^{m}$$

### Through AI Core=Through AI Core

$${B}_{n}^{m}$$

### Only Manufacturing

$${b}_{n}^{m}$$

for A revolutionary, disruptive, redefining, and changing modern business rules, modern macroeconomics, modern microeconomics, process of human being civilization and human being civilization's way or the method and the method or model or the platform created to implement this method.

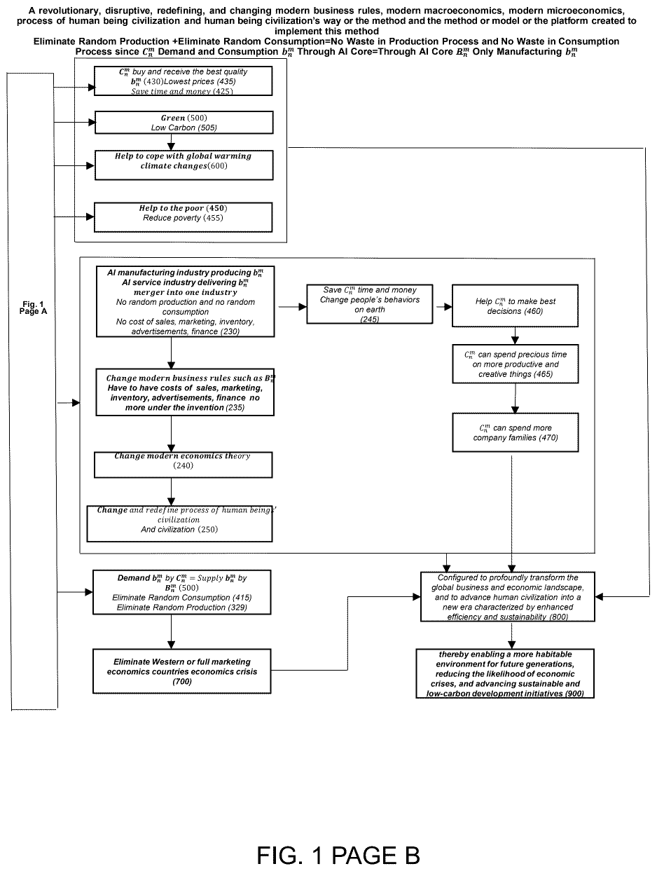

FIG. 2 illustrates manufacturers

$${B}_{n}^{m}$$

that belongs to MMPALL+S+SS+M through AI Core eliminate manufacturers eliminate

$${IB}_{n}^{m}$$

that do not Belongs to MMPALL+S+SS+M through AI Core due to

$${B}_{n}^{m}$$

have payment (revenue)

$${p}_{n}^{m}$$

from

$${C}_{n}^{m}$$

for

$${b}_{n}^{m}$$

through AI Core while

$${IB}_{n}^{m}$$

do not.

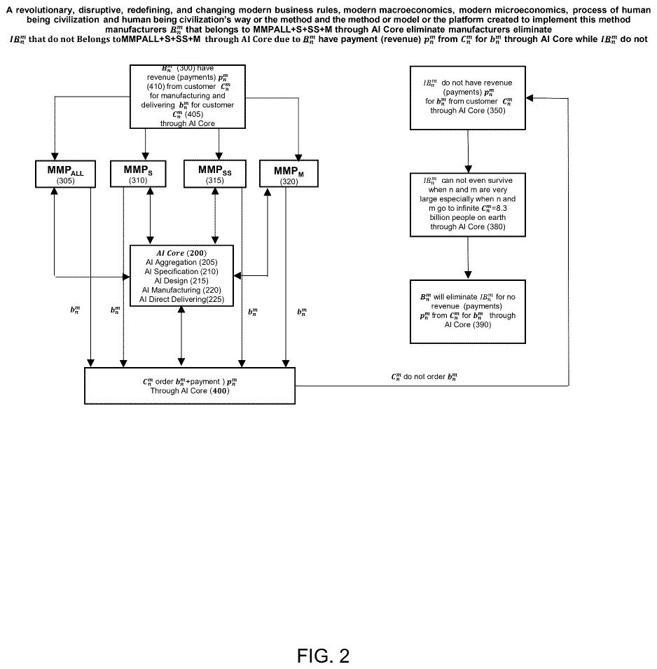

FIG. 3 illustrates manufacturers

$${B}_{n}^{m}$$

occurs No Cost of Sale, Marketing, Inventory, Advertisements (225) No Cost of Finance (230) For

$${B}_{n}^{m}$$

### to Produce

$${b}_{n}^{m}$$

since

$${B}_{n}^{m}$$

receive order

$${b}_{n}^{m}$$

and have payment (revenue)

$${p}_{n}^{m}$$

from

$${C}_{n}^{m}$$

through AI Core.

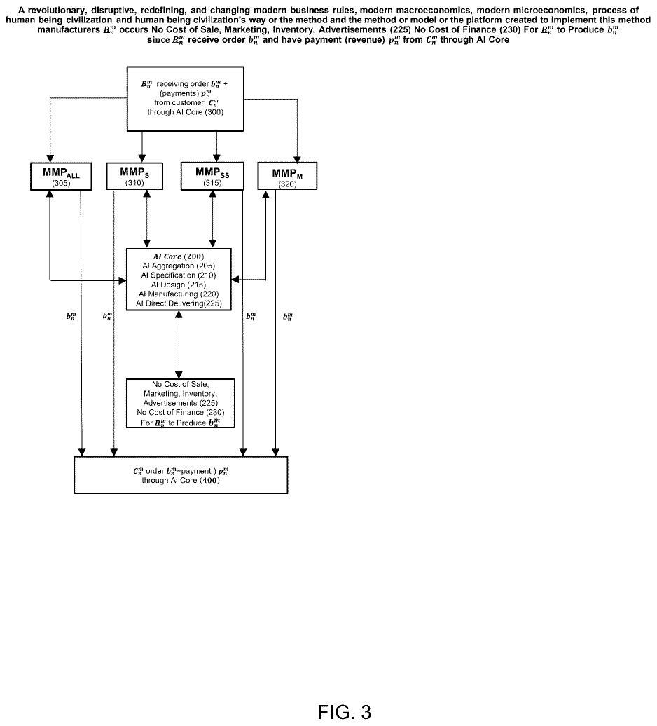

FIG. 4 illustrates manufacturers

$${B}_{n}^{m}$$

that belongs to MMPALL+S+SS+M through AI Core eliminate manufacturers do not have cost of sales, marketing, inventory, advertisement, finance (cost of S.M.I.A.F) while

$${IB}_{n}^{m}$$

that do not Belongs to MMPALL+S+SS+M do have cost of S.M.I.A.F, thereby

$${B}_{n}^{m}$$

will eliminate

$${IB}_{n}^{m} .$$

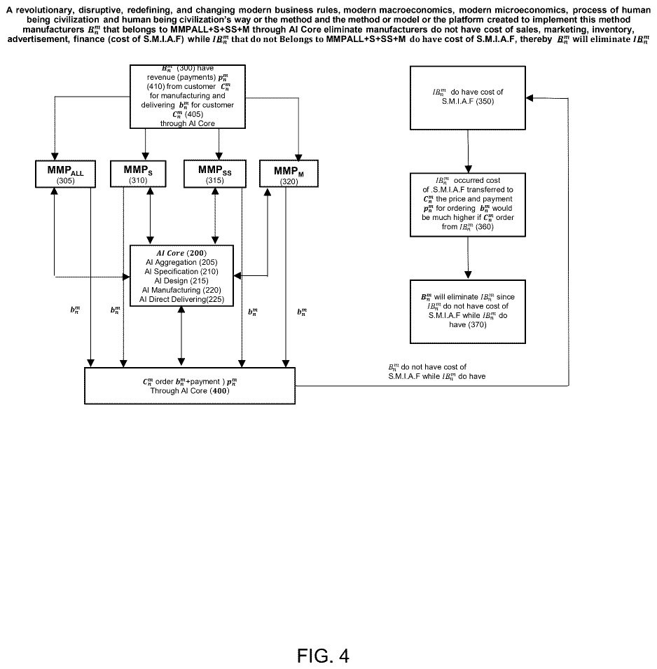

FIG. 5 illustrates

$${C}_{n}^{m}$$

save time and save money_{∘}

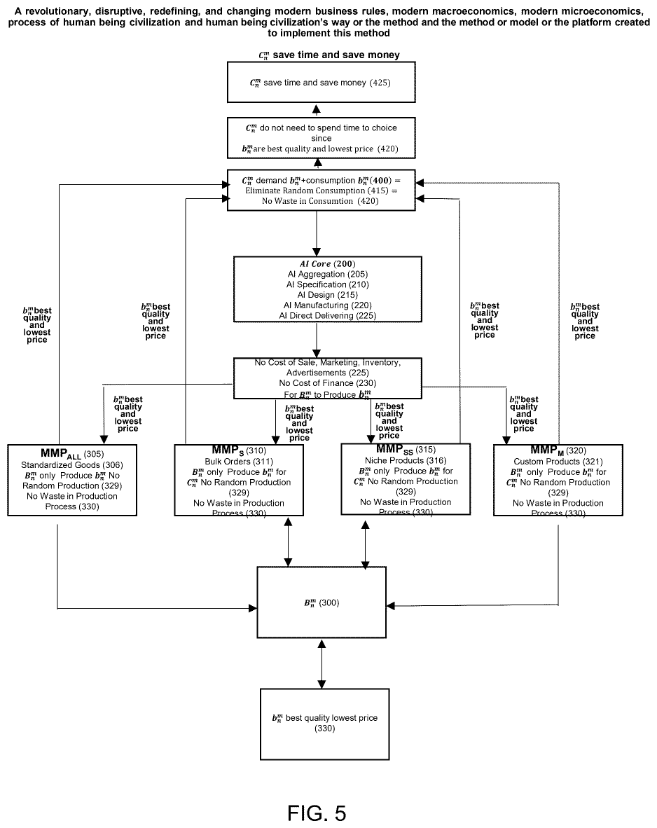

FIG. 6 illustrates the invention enables the entire manufacturing industry to become a service industry and create a wave and will eliminate manufacturers that do not belongs to the Platform.

The following is added into the specification of the invention: The method and apparatus of the present invention will now be discussed with the reference to FIG. 1. to FIG. 6. Where some notations are as follows for consistency

$$MMPALL + S + SS + M = {MMP}_{ALL + S + SS + M} ,$$

$$MMPALL = {MMP}_{ALL} ,$$

$$MMPS = {MMP}_{s} ,$$

$$MMPSS = {MMP}_{SS} ,$$

$$MMPM = {MMp}_{M} ,$$

$$C\_N \hat{} M = {C}_{n}^{m} ,$$

$$B\_N \hat{} M = {B}_{n}^{m} ,$$

$$b\_n \hat{} m = {b}_{n}^{m} ,$$

$$p\_n \hat{} m = {p}_{n}^{m} .$$

### FIG. 1

### DETAILED DESCRIPTION OF THE INVENTION

The present invention, embodied in the MMPALL+S+SS+M platform (hereinafter referred to as “the Platform”), revolutionizes global commerce by enabling manufacturers to produce and deliver products directly to consumers through an AI-driven core, optimizing product quality, minimizing costs, and aggregating consumer demand to achieve the best cost-performance ratio. This detailed description focuses on FIG. 1 of the accompanying drawings, titled “Customers C_N\hat{ }M Demanding Data Aggregation.” This section complies with the requirements of the United States Patent and Trademark Office (USPTO), addressing 35 U.S.C. 112(b) and 35 U.S.C. 101, while providing a clear, specific, and operative method description. The description emphasizes the aggregation of consumer demand and the use of AI to deliver the best quality products at the lowest prices, as supported by Claim 1 of the patent application, and aligns with the hand-drawn schematic provided in FIG. 1.

### 1. Overview of the Invention

The MMPALL+S+SS+M platform transforms traditional manufacturing and retail by facilitating direct transactions between manufacturers (B_N\hat{ }M) and consumers (C_N\hat{ }M) through an AI Core. The Platform leverages advanced technologies, including big data, cloud computing, machine learning, 5G, and photon quantum computing, to aggregate consumer demand, optimize product design and production, and deliver products with the best quality and lowest prices globally. By aggregating exact demand quantities (N>No), the Platform ensures economies of scale, eliminates fixed costs (sales, marketing, inventory, advertisement, finance), and avoids random production and consumption. This consumer-driven model supports a wide range of products and services, from necessities (clothing, food, shelter) to specialized needs (healthcare, education), meeting the demands of a global population from birth to death.

FIG. 1 illustrates the process of aggregating consumer demand through the AI Core, which coordinates AI-driven specification, design, manufacturing, and direct delivery to produce high-quality, low-cost products. The schematic highlights the Platform's ability to categorize products across standardized, bulk, niche, and custom segments, ensuring flexibility and scalability. This aligns with Claim 1, which articulate the Platform's capacity to deliver products with the best cost-performance ratio through AI(optimization and demand aggregation.

### 2. FIG. 1: System Architecture and Process Flow

FIG. 1 depicts the operational framework of the MMPALL+S+SS+M platform, focusing on the aggregation of consumer demand and the AI-driven production process. The schematic includes labeled components and processes, as follows:

### 2.1 Components of the System

AI Core (200): The central processing hub of the Platform, responsible for aggregating consumer demand, specifying product requirements, designing products, coordinating manufacturing, and processing payments. The AI Core leverages advanced technologies to optimize quality and cost.
AI Aggregation (205): The process of collecting and analyzing consumer demand data to determine the exact quantity (N>No) and type (M) of products required.
AI Specification (210): The AI-driven process of defining product specifications based on consumer needs and market trends.
AI Design (215): The AI-driven design phase, where products are tailored to meet consumer preferences and quality standards.
AI Manufacturing (220): The AI-coordinated production phase, ensuring efficient, high-quality manufacturing with minimal costs.
Manufacturers B_N\hat{ }M (300): Efficient manufacturers registered on the Platform, belonging to one or more tiers:
   MMPALL (305): Standardized goods (306), such as clothing and electronics.
   MMPS (310): Bulk orders (311), such as appliances.
   MMPSS (315): Niche products (316), such as handcrafted items.
   MMPM (320): Custom products (316), such as personalized items.
Customers C_N\hat{ }M (400): Global consumers who place orders for products (b_n\hat{ }m, 405) and provide payments (p_n\hat{ }m) through the AI Core. The Platform supports a scalable consumer base, potentially encompassing 8.3 billion people.
Products b_n\hat{ }m (405): Goods or services produced by B_N\hat{ }M, characterized by the best quality and lowest prices in their categories, achieved through AI optimization and demand-driven production.
Payments p_n\hat{ }m: Financial transactions from C_N\hat{ }M to B_N\hat{ }M, processed through the AI Core. Full payments are received before production, eliminating financial costs.
Cost Elimination (325, 330): The absence of fixed costs (sales, marketing, inventory, advertisement) and financial costs (interest), enabling competitive pricing.
Direct Delivery: The AI-coordinated delivery of products directly from B_N\hat{ }M to C_N\hat{ }M, bypassing retail layers.

### 2.2 Process Flow

The process begins with consumers (C_N\hat{ }M, 400) submitting orders for products (b_n\hat{ }m, 405) and payments (p_n\hat{ }m) through the AI Core (200). The AI Core performs the following steps:
1. AI Aggregation (205): Collects and analyzes consumer demand data to determine the exact quantity (N>No) and type (M) of products required. This ensures precise demand forecasting, unlike traditional market estimates.
2. AI Specification (210): Defines product specifications based on consumer preferences, historical data, and market trends, ensuring products meet the highest quality standards.
3. AI Design (215): Designs products using AI-driven insights, optimizing for quality, functionality, and cost-effectiveness, similar to how leading manufacturers innovate in their categories.
4. AI Manufacturing (220): Coordinates production by assigning orders to B_N\hat{ }M (300) under MMPALL (305), MMPS (310), MMPSS (315), or MMPM (320), ensuring efficient, high-quality output.

Manufacturers produce products without incurring fixed costs:
Sales Costs: Eliminated through direct manufacturer-consumer interactions.
Marketing Costs: Replaced by AI-driven demand analysis.
Inventory Costs: Avoided through on-demand production.
Advertisement Costs: Obviated by AI-based product matching.
Finance (Interest) Costs: Eliminated, as full payments cover production costs.

The AI Core coordinates direct delivery of products to consumers, bypassing retail layers. This results in products with the best quality and lowest prices, achieving the best cost-performance ratio globally.

### 3. Demand Aggregation and Product Optimization

Claim 1 articulate the Platform's core innovations: aggregating consumer demand to achieve economies of scale, using AI to optimize product quality, and delivering products with the best cost-performance ratio. This section elaborates on these mechanisms.

### 3.1 Demand Aggregation (Claim 1)

The Platform aggregates consumer demand to achieve economies of scale, reducing per-unit costs and enabling the lowest prices. The AI Core collects exact demand quantities (N>No), ensuring no overproduction or waste. This contrasts with traditional models, such as China's National Healthcare Security Administration's drug procurement, which relies on estimated quantities. The Platform's exact demand aggregation:
Scales Globally: Supports a consumer base of up to 8.3 billion people, covering necessities (clothing, food, shelter) and services (healthcare, education).
Optimizes Costs: Large order quantities (N>No) enable bulk production, lowering costs for standardized (MMPALL), bulk (MMPS), niche (MMPSS), and custom (MMPM) products.
Ensures Precision: Exact demand data eliminates random production and consumption, aligning supply with consumer needs.

For example, if 1 million consumers order smartphones, the AI Core aggregates this demand, assigns production to a B_N\hat{ }M under MMPALL, and secures full payments upfront, enabling production at the lowest cost.

### 3.2 AI-Driven Quality Optimization (Claim 1)

The Platform uses AI to achieve the best product quality, as articulated in Claim 1. The AI Core employs advanced technologies:
Big Data: Analyzes consumer preferences and market trends to inform product design.
Machine Learning: Optimizes production processes, enhancing quality and efficiency.
Cloud Computing: Enables real-time coordination across the supply chain.
5G: Facilitates rapid data transfer for seamless order processing.
Photon Quantum Computing: Enhances computational efficiency for complex design and forecasting.

This AI-driven approach ensures products are not merely responses to market demand but are innovative, forward-looking solutions, similar to how leading manufacturers create category-defining products. For instance:
In electronics, the AI Core designs smartphones with superior features and durability, tailored to consumer needs.
In fashion, the AI Core creates clothing that balances style, comfort, and affordability, based on real-time consumer data.

This disrupts traditional sales concepts, as products are proactively designed to meet future needs, ensuring market success.

### 3.3 Best Cost-Performance Ratio (Claim 1)

The Platform delivers products with the best cost-performance ratio, as articulated in Claims 1. This is achieved through:
Lowest Prices: Demand aggregation and cost elimination (325, 330) enable prices 25%-40% below market rates.
Highest Quality: AI-driven design and manufacturing ensure superior performance and durability.
Global Accessibility: Products and services meet diverse needs, from birth to death, across all industries.

For example, in healthcare, the Platform delivers medical supplies with the highest quality at the lowest prices, ensuring accessibility for global consumers.

### 4. Consumer Benefits

The Platform delivers significant benefits to consumers (C_N\hat{ }M):
Cost Savings: Products priced 25%-40% below market rates due to cost-free production and demand aggregation.
Superior Quality: AI-optimized products meet the highest standards in their categories.
Time Efficiency: Direct delivery and AI-driven recommendations eliminate research and comparison time.
Comprehensive Coverage: Supports necessities (clothing, food, shelter) and services (healthcare, education), meeting lifecycle needs.
Global Reach: Accessible to a potential 8.3 billion consumers, ensuring equitable access.

### 5. Compliance with USPTO Requirements

This description ensures compliance with USPTO requirements:

5.1 35 U.S.C. 112(b)—Indefiniteness

The description presents a clear, operative method in a structured format, with each process step articulated concisely. Trademark references (e.g., Apple) have been replaced with generic descriptions (e.g., “leading manufacturers”). The process flow is organized to delineate each step, from demand aggregation to delivery, ensuring clarity and specificity. For example:
“Consumers (C_N\hat{ }M) submit orders and payments (p_n\hat{ }m) through the AI Core (200), which aggregates demand (205), specifies products (210), designs them (215), coordinates manufacturing (220), and delivers high-quality, low-cost products directly from B_N\hat{ }M.”

### 5.2 35 U.S.C. 101—Abstract Idea

The invention integrates the abstract idea of facilitating transactions into a practical application through:
Specific Technical Solution: The AI Core leverages advanced technologies to aggregate demand, optimize quality, and eliminate costs, transforming commerce.
Technical Improvement: Demand aggregation and AI-driven production eliminate inefficiencies, reducing costs and waste.
Tangible Benefits: Consumers receive high-quality, low-cost products, and manufacturers operate efficiently, ensuring scalability and global impact.

The AI Core and platform tiers are not generic computer functions but are specifically designed to optimize global commerce.

### 6. Comparison with Prior Art

The MMPALL+S+SS+M platform distinguishes itself from prior art. Key differences include:
Demand Aggregation: The Platform uses exact demand quantities (N>No), unlike prior art's model.
AI Optimization: The AI Core designs and produces innovative products.
Cost Elimination: The Platform eliminates fixed and financial costs, enabling lower prices, a feature not addressed by prior art.

This results in a more efficient, scalable, and consumer-centric model.

### 7. Scalability and Global Impact

The Platform is designed to scale globally, supporting up to 8.3 billion consumers. As N and M increase, the AI Core's ability to aggregate demand and optimize production ensures continued efficiency. Key scalability features include:
Global Connectivity: 5G and cloud computing enable real-time coordination.
AI Adaptability: Machine learning supports diverse consumer needs.
Flexible Tiers: MMPALL, MMPS, MMPSS, and MMPM accommodate standardized, bulk, niche, and custom products.

The Platform's ability to meet global needs underscores its transformative potential.

### 8. Security and Authentication

The Platform employs cryptographic protocols, to ensure secure transactions:
Digital Signatures: Authenticate consumers and manufacturers.
Encryption: Protect payment and order data.
Secure Database: Maintain tamper-proof transaction records.

These measures ensure trust and reliability for large-scale, pre-paid orders.

### 9. Implementation Examples

### 9.1 Electronics (MMPALL)

Consumers order 1 million smartphones through the AI Core.
The AI Core aggregates demand, designs a high-quality smartphone, and assigns production to a B_N\hat{ }M.
The smartphones are delivered directly at 25% below market prices, with no fixed or financial costs.

### 9.2 Appliances (MMPS)

Consumers order bulk appliances (e.g., refrigerators). The AI Core aggregates demand and coordinates production, ensuring low costs and high quality.

### 9.3 Handcrafted Items (MMPSS)

Consumers order niche, handcrafted products. The AI Core designs and assigns production to specialized B_N\hat{ }M, delivering unique items at competitive prices.

### 9.4 Personalized Products (MMPM)

Consumers order custom products (e.g., tailored clothing). The AI Core designs and coordinates production, ensuring personalization without cost overhead.

### 10. Conclusion

The MMPALL+S+SS+M platform revolutionizes commerce by aggregating consumer demand and leveraging AI to deliver high-quality, low-cost products. By eliminating fixed and financial costs, the Platform achieves the best cost-performance ratio, meeting global consumer needs from birth to death. The flexible tier structure and AI-driven processes ensure scalability and efficiency, while direct delivery enhances consumer convenience. This description complies with USPTO requirements, addressing indefiniteness and abstract idea concerns, and positions the invention as a transformative advancement in global commerce.

### FIG. 2.

### DETAILED DESCRIPTION OF THE INVENTION

The present invention, developed by Dr. Chuanping Hu, pertains to a method and platform utilizing advanced artificial intelligence (AI) technologies to revolutionize the production, distribution, and consumption of goods and services globally by eliminating random production and consumption, thereby eradicating waste across all industries and products. The following description corresponds to the hand-drawn diagrams provided in the first attached file, detailing the operational flow and components of the AI-driven platform through FIGS. 1 to 6, with an in-depth focus on FIG. 2 as the cornerstone of the invention. This description ensures compliance with USPTO requirements under 35 U.S.C. § 112(b) and overcoming the 35 U.S.C. § 101 rejection by demonstrating a practical application that improves technological processes beyond a mere abstract idea.

### FIG. 1: Overview of the AI-Driven Platform

FIG. 1 illustrates the comprehensive structure of the invention, wherein a central AI Core (200) integrates consumers (denoted as C_n\hat{ }m) and manufacturers (denoted as B_N\hat{ }M) to facilitate a seamless flow of goods and services; specifically, consumers input their demands via an interface (400) into the AI Core (200), which processes these demands and instructs manufacturers to produce only the demanded goods (b_n0\hat{ }m0), followed by direct delivery (225) to consumers, thereby eliminating traditional retail intermediaries and associated costs such as sales, marketing, inventory, and advertisement, ensuring that production aligns precisely with consumption to minimize waste.

### FIG. 1: AI Core Components

FIG. 1 delineates the internal architecture of the AI Core (200), comprising five synergistic sub-components: AI Aggregation (205), AI Specification (210), AI Design (215), AI Manufacturing (220), and AI Direct Delivery (225); the process initiates with AI Aggregation (205) compiling global consumer demand data, followed by AI Specification (210) defining precise product requirements, AI Design (215) generating optimized product designs, AI Manufacturing (220) directing production based on these designs, and AI Direct Delivery (225) coordinating efficient distribution directly to consumers, collectively ensuring that production matches verified consumer needs without randomness or excess.

### FIG. 1: Manufacturer Interaction

FIG. 1 depicts the interaction between the AI Core (200) and manufacturers (B_N\hat{ }M, labeled 300), wherein manufacturers receive specific production instructions (b_n0\hat{ }m0, labeled 405) and payment confirmations (p_n0\hat{ }m0, labeled 410) from the AI Core (200); this interaction eliminates the need for manufacturers to incur expenses related to sales, marketing, inventory, advertisement, or financing, as production commences only upon receipt of payment, thereby preventing overproduction and reducing waste in the manufacturing process.

### FIG. 1: Consumer Demand Input

FIG. 4 focuses on the consumer interface, illustrating how consumers (C_n\hat{ }m) input their specific demands and consumption preferences (b_n0\hat{ }m0) into the AI Core (200) through an interface (400); the AI Core validates these inputs to ensure specificity and quantifiability, processes payments (p_n0\hat{ }m0, labeled 410) from consumers, and links these demands directly to manufacturer production, bypassing intermediaries to prevent random consumption patterns and align consumption with production output.

### FIG. 1: Distribution and Delivery

FIG. 1 outlines the distribution mechanism, wherein AI Direct Delivery (225) manages the transfer of manufactured goods (b_n0\hat{ }m0) from manufacturers (B_N\hat{ }M) to consumers (C_n\hat{ }m) without retail channels; this direct delivery model eliminates waste in distribution by ensuring that goods are delivered only as demanded, enhancing efficiency and supporting the invention's objective of waste elimination across the supply chain.

FIG. 1: Eliminate Random Production+Eliminate Random Consumption=No Waste in Production Process and No Waste in Consumption Process since C_n\hat{ }m Demand and Consumption b_n0\hat{ }m0 through AI Core=through AI Core B_N\hat{ }M only Manufacturing b_n0\hat{ }m0

FIG. 1 embodies the core innovation of the invention, demonstrating a method wherein consumers (C_n0\hat{ }m0) input their specific demands and consumption needs (b_n0\hat{ }m0) into the AI Core (200) via an interface (400), and the AI Core (200) processes these inputs through its sub-components-AI Aggregation (205) compiles the demand data, AI Specification (210) defines exact product requirements, AI Design (215) optimizes product designs, AI Manufacturing (220) directs production, and AI Direct Delivery (225) ensures efficient distribution—to manufacturers (B_N0\hat{ }M0, labeled 300), who receive payments (p_n0\hat{ }m0, labeled 410) from consumers through the AI Core (200) and produce only the demanded goods (b_n0\hat{ }m0, labeled 405), thereby eliminating random production and ensuring no waste in the production process (330); concurrently, consumers (C_n0\hat{ }m0) order and consume only what they need (b_n0\hat{ }m0) via the AI Core (200), with direct delivery (225) from manufacturers bypassing retail intermediaries, eliminating random consumption and ensuring no waste in the consumption process.

The AI Core (200) assigns production tasks based on demand volume: MMPALL (305) manages standardized goods (306) for general demand, MMPS (310) handles bulk orders where demand exceeds a threshold (N>N0), MMPSS (315) addresses niche products where demand is below the threshold (N<N0), and MMPM (320) oversees bulk custom orders; this segmentation ensures production is precisely tailored to consumer needs, avoiding overproduction, while manufacturers incur no costs for sales, marketing, inventory, advertisement, or financing, as all demands (b_n0\hat{ }m0) and payments (p_n0\hat{ }m0) are processed through the AI Core (200), further reducing waste in the production process (330).

Alignment with Claim 2

Claim 2: The method completely eradicates random production and consumption, which have persisted since ancient times across human civilization, by leveraging the AI Core (200) to synchronize production with consumer demand; unlike traditional economic models where supply often misaligns with demand, this invention ensures manufacturers (B_N0\hat{ }M0) produce only what consumers (C_n0\hat{ }m0) request (b_n0\hat{ }m0), eliminating randomness in both production and consumption processes.

Claim 2: Building on Claim, the method eliminates the enormous waste resulting from supply-demand imbalances across all industries and products by ensuring that production and consumption are precisely matched through the AI Core (200); for example, as reported by the Alibaba Research Institute (First Finance, January 2021), the Chinese clothing industry incurs annual waste of 800 billion to 1.2 trillion yuan, with 400 billion yuan from production and 400 billion to 800 billion yuan from distribution and consumption, and this invention addresses such waste universally by preventing overproduction and excess consumption through AI-driven synchronization.

### Technological Implementation

The AI Core (200) employs advanced technologies—including big data for aggregating demand, cloud computing for processing data, machine learning for optimizing designs and predictions, 5G for rapid communication, and photon quantum computing for complex computations—to execute this method; however, the novelty lies not in these technologies themselves but in their integrated application to eliminate waste by ensuring that manufacturers produce only what is demanded (b_n0\hat{ }m0) and consumers receive only what they need, transforming global commerce into a waste-free system.

This practical application integrates the abstract idea of facilitating transactions into a technological improvement, enhancing the efficiency and sustainability of production and consumption systems worldwide, thus satisfying 35 U.S.C. § 101 by providing significantly more than a judicial exception.

### FIG. 2

### DETAILED DESCRIPTION OF THE INVENTION

The present invention relates to a method and platform designed to facilitate direct transactions between manufacturers and consumers, leveraging advanced artificial intelligence (AI) technologies to optimize efficiency, product quality, and cost-performance ratios. This detailed description focuses on FIG. 2 of the accompanying drawings, titled “Manufacturers B_N\hat{ }M Belongs to MMPALL+S+SS+M through AI Core Eliminate Manufacturers IB_N\hat{ }M do not belong to MMPALL+S+SS+M through AI Core. B_N\hat{ }M Will Eliminate IB_N\hat{ }M due to B_N\hat{ }M has payments (revenue) p_n\hat{ }m from Customers C_N\hat{ }M for Products b_n\hat{ }m through AI Core While IB_N\hat{ }M do not.” This section addresses the requirements set forth by the USPTO, ensuring clarity, specificity, and compliance with 35 U.S.C. 112(b) and 35 U.S.C. 101.
1. Overview of the Invention The invention proposes a novel retail and non-retail platform, herein referred to as MMPALL+S+SS+M, which integrates manufacturers (denoted as B_N\hat{ }M) and consumers (denoted as C_N\hat{ }M) through an AI-driven core (AI Core). The platform eliminates inefficiencies in traditional retail and wholesale models by enabling direct, demand-driven production, supply, and distribution of products (b_n\hat{ }m) with payments (p_n\hat{ }m) flowing from consumers to manufacturers. The AI Core optimizes transactions, product quality, and pricing by leveraging technologies such as big data, cloud computing, machine learning, 5G, and photon quantum computing. The platform ensures that only the most efficient and effective manufacturers (B_N\hat{ }M) thrive, eliminating less competitive manufacturers (IB_N\hat{ }M) that do not participate in the platform.
2. FIG. 2: System Architecture and Process Flow FIG. 2 illustrates the operational framework of the MMPALL+S+SS+M platform, emphasizing the competitive advantage of manufacturers B_N\hat{ }M over IB_N\hat{ }M due to revenue generation through consumer demand. The key components and processes are described below:

### 2.1 Components of the System

AI Core (200): The central processing unit of the platform, responsible for coordinating transactions, optimizing product quality, and determining pricing based on consumer demand. The AI Core integrates advanced technologies to analyze consumer preferences, forecast demand, and ensure the best cost-performance ratio for products.
Manufacturers B_N\hat{ }M (300): These are efficient and effective manufacturers registered on the MMPALL+S+SS+M platform. They belong to one or more platform tiers: MMPALL (305), MMPS (310), MMPSS (315), or MMPM (320). Each tier represents a specialized segment of the platform, such as large-scale production, specialized services, or modular manufacturing.
Customers C_N\hat{ }M (400): Consumers or members who place orders for products (b_n\hat{ }m) through the AI Core, providing payments (p_n\hat{ }m) directly to B_N\hat{ }M. The platform supports a global consumer base, potentially scaling to 8.3 billion people.
Products b_n\hat{ }m (405): Goods or services produced and delivered by B_N\hat{ }M to meet consumer demand. These products are characterized by the best quality and lowest price in their respective categories, achieved through AI-driven optimization.
Manufacturers IB_N\hat{ }M (350): Inefficient or ineffective manufacturers that do not participate in the MMPALL+S+SS+M platform. These entities lack access to the AI Core and consumer demand, resulting in no revenue (p_n\hat{ }m) from C_N\hat{ }M.
Elimination Process (380, 390): The competitive mechanism by which B_N\hat{ }M, supported by consumer payments, outcompetes and eliminates IB_N\hat{ }M, which cannot survive without revenue.

### 2.2 Process Flow

The process begins with consumers (C_N\hat{ }M, 400) submitting orders for products (b_n\hat{ }m, 405) through the AI Core (200). The AI Core processes these orders, aggregating demand to determine the quantity (N) and type (M) of products required. Manufacturers B_N\hat{ }M (300), registered under MMPALL (305), MMPS (310), MMPSS (315), or MMPM (320), receive these orders and produce the requested products. Upon delivery, consumers provide payments (p_n\hat{ }m) to B_N\hat{ }M, generating revenue for these manufacturers.

In contrast, manufacturers IB_N\hat{ }M (350) do not receive orders from C_N\hat{ }M because they are not integrated with the AI Core. Consequently, IB_N\hat{ }M lack revenue (p_n\hat{ }m) and cannot sustain operations, especially as N and M scale to large values or approach infinity (e.g., when C_N\hat{ }M represents the global population of 8.3 billion). This competitive disadvantage leads to the elimination of IB_N\hat{ }M (380, 390), as B_N\hat{ }M dominate the market through efficient production and direct consumer engagement.

### 3. Elimination of Inefficient Manufacturers

The invention fundamentally disrupts traditional business models by prioritizing efficiency and effectiveness. The MMPALL+S+SS+M platform ensures that only manufacturers capable of delivering high-quality products at the lowest prices survive. This is achieved through the following mechanisms:

### 3.1 Demand-Driven Production

Consumers (C_N\hat{ }M) dictate production by specifying their needs through the AI Core. Unlike traditional retail, where manufacturers produce based on market estimates, the platform uses exact demand quantities (N>No) to optimize production schedules and resource allocation. This eliminates overproduction and waste, making B_N\hat{ }M more efficient than IB_N\hat{ }M, which rely on less accurate forecasting methods.

### 3.2 AI-Driven Optimization

The AI Core (200) employs advanced technologies to enhance product quality and reduce costs. For example:
Big Data: Analyzes consumer preferences and historical demand to predict trends.
Machine Learning: Refines production processes by identifying inefficiencies.
Cloud Computing: Enables real-time coordination between manufacturers and consumers.
5G and Photon Quantum Computing: Facilitates rapid data processing and secure transactions.

These technologies ensure that B_N\hat{ }M produce products with the best cost-performance ratio, similar to how leading companies like Apple achieve superior quality in their product categories.

### 3.3 Economies of Scale

By aggregating consumer demand (N>No), the platform enables B_N\hat{ }M to achieve economies of scale, reducing per-unit costs. This contrasts with IB_N\hat{ }M, which cannot access the same volume of demand and thus face higher production costs. As N approaches infinity, the cost advantage of B_N\hat{ }M becomes insurmountable, leading to the elimination of IB_N\hat{ }M.

### 4. Consumer Benefits

The MMPALL+S+SS+M platform empowers consumers by allowing them to exchange volume for price. By aggregating demand, consumers secure products at the lowest possible prices while ensuring the highest quality. The platform supports a wide range of products and services, including:
Clothing
Food
Shelter
Entertainment
Education
Healthcare
Elderly care
Child care

This comprehensive coverage ensures that consumers receive essential goods and services from birth to death, all optimized for quality and cost.

### 5. Compliance with USPTO Requirements

The following clarifications are provided:

### 5.1 35 U.S.C. 101—Abstract Idea

The invention integrates the abstract idea of facilitating transactions into a practical application by:
Providing a specific technical solution using the AI Core, which leverages advanced technologies (big data, machine learning, etc.) to optimize production and distribution.
Improving the efficiency of manufacturing and retail processes by eliminating intermediaries and enabling direct consumer-manufacturer interactions.
Delivering tangible benefits, such as the best quality products at the lowest prices, through a scalable platform.

The additional elements (AI Core, platform tiers, and demand aggregation) are not merely generic computer functions but are specifically designed to transform traditional commerce into a novel, consumer-driven model.

### 6. Comparison with Prior Art

The invention distinguishes itself from prior art, by focusing on manufacturer-consumer transactions rather than buyer-driven purchase offers. The MMPALL+S+SS+M platform directly connects manufacturers to consumers, bypassing intermediaries and optimizing production based on exact demand. This eliminates inefficiencies inherent in traditional retail and wholesale models, a feature not addressed by prior art's system.

### 7. Scalability and Global Impact

The platform is designed to scale globally, supporting transactions for a consumer base of up to 8.3 billion people. As N and M increase, the competitive advantage of B_N\hat{ }M grows, ensuring that only the most efficient manufacturers survive. This scalability is supported by the AI Core's ability to process vast amounts of data and coordinate transactions across industries and regions.

### 8. Security and Authentication

To ensure secure transactions, the platform employs cryptographic protocols. Manufacturers and consumers are authenticated through digital signatures and encryption, ensuring trust and non-repudiation. The AI Core maintains a secure database of transactions, protecting against fraud and unauthorized access.

### 9. Implementation Example

Consider a scenario where consumers demand smartphones. Through the AI Core, C_N\hat{ }M submit orders for 10 million units (N=10M). The AI Core aggregates this demand and assigns production to B_N\hat{ }M, who produce smartphones with superior quality and a cost-performance ratio unmatched by IB_N\hat{ }M. Consumers receive the smartphones at a lower price due to economies of scale, while IB_N\hat{ }M, lacking access to this demand, cannot compete and are eliminated from the market.

### 10. Conclusion

The MMPALL+S+SS+M platform revolutionizes commerce by enabling direct, AI-driven transactions between manufacturers and consumers. By eliminating inefficient manufacturers (IB_N\hat{ }M) and optimizing production through the AI Core, the platform ensures that B_N\hat{ }M deliver the best quality products at the lowest prices. This invention addresses global consumer needs, complies with USPTO requirements, and offers a scalable, secure, and efficient solution for modern commerce.

FIG. 3

### DETAILED DESCRIPTION OF THE INVENTION

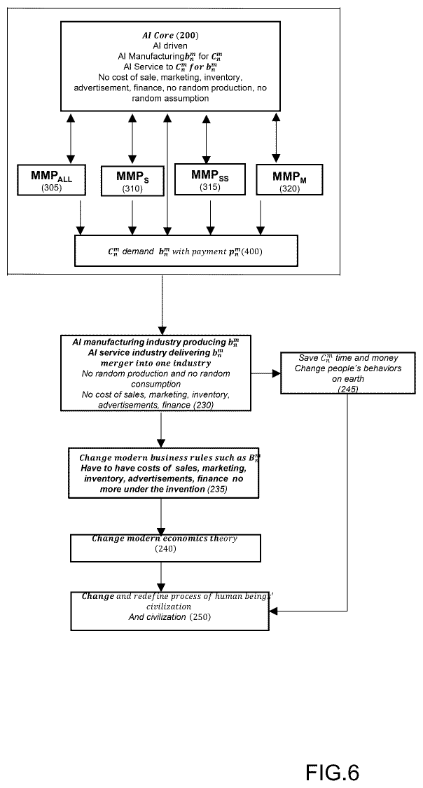

The present invention, embodied in the MMPALL+S+SS+M platform (hereinafter referred to as “the Platform”), introduces a transformative method for facilitating direct transactions between manufacturers and consumers, leveraging an artificial intelligence (AI) core to eliminate traditional business costs and inefficiencies. This detailed description focuses on FIG. 8 of the accompanying drawings, titled “Manufacturers B_N\hat{ }M Occurs No Cost of Sales, Marketing, Inventory, Advertisement, Finance (Interests) Since B_N\hat{ }M received Ordered Products b_n\hat{ }m and Payments p_n\hat{ }m from Customers C_N\hat{ }M through AI Core.” This section addresses the requirements of the United States Patent and Trademark Office (USPTO), ensuring compliance with 35 U.S.C. 112(b) and 35 U.S.C. 101, while providing a clear, specific, and operative method description. The description emphasizes the elimination of fixed costs for manufacturers, as supported by Claim 3 of the patent application, and aligns with the hand-drawn schematic provided in

### FIG. 3.

### 1. Overview of the Invention

The MMPALL+S+SS+M platform redefines modem commerce by enabling manufacturers (denoted as B_N\hat{ }M) to produce and deliver products (b_n\hat{ }m) directly to consumers (C_N\hat{ }M) based on precise demand, facilitated through an AI Core. Unlike traditional retail and wholesale models, which incur significant fixed costs such as sales, marketing, inventory, advertisement, and financial interest expenses, the Platform eliminates these costs by securing full payments (p_n\hat{ }m) from consumers before production begins. This demand-driven, AI-optimized approach ensures that manufacturers operate with unparalleled efficiency, delivering the highest quality products at the lowest prices globally. The invention disrupts conventional business rules by integrating advanced technologies, including big data, cloud computing, machine learning, 5G, and photon quantum computing, to streamline production and distribution processes.

FIG. 3 illustrates the operational mechanism by which manufacturers B_N\hat{ }M avoid traditional costs, as they receive orders and payments directly from consumers through the AI Core. This cost elimination provides a competitive advantage, enabling B_N\hat{ }M to offer products at prices 25% to 40% lower than market rates, as exemplified in real estate crowdfunding scenarios. The Platform's structure ensures scalability, security, and global applicability, supporting a consumer base potentially encompassing 8.3 billion people.

### 2. FIG. 3: System Architecture and Process Flow

FIG. 3 depicts the core functionality of the MMPALL+S+SS+M platform, highlighting how manufacturers B_N\hat{ }M incur no costs for sales, marketing, inventory, advertisement, or finance (interest) due to the receipt of orders and payments from consumers through the AI Core. The schematic includes labeled components and processes, as follows:

### 2.1 Components of the System

AI Core (200): The central processing hub of the Platform, responsible for receiving consumer orders, aggregating demand, coordinating production, and processing payments. The AI Core utilizes advanced technologies (e.g., big data analytics, machine learning, cloud computing, 5G, and photon quantum computing) to optimize product quality, pricing, and delivery schedules.
Manufacturers B_N\hat{ }M (300): Efficient manufacturers registered on the Platform, belonging to one or more tiers: MMPALL (305), MMPS (310), MMPSS (315), or MMPM (320). These tiers represent different scales and types of manufacturing, from large-scale production (MMPALL) to micro-enterprises (MMPM).
Customers C_N\hat{ }M (400): Global consumers who place orders for products (b_n\hat{ }m) and provide payments (p_n\hat{ }m) through the AI Core. The Platform supports a scalable consumer base, ranging from small groups to the entire global population.
Products b_n\hat{ }m (405): Goods or services produced by B_N\hat{ }M in response to consumer orders. These products are optimized for the best quality and lowest price in their respective categories, achieved through AI-driven design and production processes.
Payments p_n\hat{ }m: Financial transactions from C_N\hat{ }M to B_N\hat{ }M, processed through the AI Core. Payments are received in full before production, eliminating the need for manufacturers to incur debt or maintain inventory.

### 2.2 Process Flow

The process begins with consumers (C_N\hat{ }M, 400) submitting orders for products (b_n\hat{ }m, 405) through the AI Core (200). The AI Core aggregates these orders, determining the exact quantity (N) and type (M) of products required. Manufacturers B_N\hat{ }M (300), registered under MMPALL (305), MMPS (310), MMPSS (315), or MMPM (320), receive these orders along with full payments (p_n\hat{ }m) from C_N\hat{ }M. The AI Core ensures that the orders are matched with the appropriate manufacturers based on production capacity and product specifications.

Upon receiving orders and payments, B_N\hat{ }M produce and deliver the products without incurring traditional costs:
Sales Costs: Eliminated because the Platform directly connects manufacturers to consumers, bypassing intermediaries.
Marketing Costs: Unnecessary, as the AI Core promotes products based on consumer demand data.
Inventory Costs: Avoided, as production occurs only after orders and payments are received.
Advertisement Costs: Obviated, as the Platform uses AI-driven recommendations to match products with consumers.
Finance (Interest) Costs: Eliminated, as full payments cover production costs, negating the need for bank loans.

This process ensures that B_N\hat{ }M operate with maximum efficiency, delivering products at significantly lower prices than competitors outside the Platform.

### 3. Elimination of Traditional Costs

The invention's core innovation lies in its ability to eliminate fixed costs that burden traditional manufacturers. Claim 3 of the patent application articulates this advantage, stating that manufacturers on the Platform do not incur costs for advertising, sales, marketing, inventory, or financial interest. This section elaborates on how the Platform achieves this cost elimination, with a focus on the real estate crowdfunding example provided in the patent documents.

### 3.1 Demand-Driven Production

The Platform operates on a consumer-to-business (C2B) model, where production is initiated only after consumers place orders and provide full payments. This contrasts with traditional business-to-consumer (B2C) models, where manufacturers produce goods based on market forecasts, often leading to overproduction and inventory costs. By aggregating exact demand quantities (N>No), the AI Core ensures that B_N\hat{ }M produce only what is needed, eliminating inventory costs and waste.

### 3.2 AI-Driven Optimization

The AI Core (200) leverages advanced technologies to streamline production and distribution:
Big Data Analytics: Collects and analyzes consumer demand data to predict preferences and optimize product offerings.
Machine Learning: Refines manufacturing processes by identifying inefficiencies and enhancing quality control.
Cloud Computing: Enables real-time coordination between manufacturers and consumers, reducing delays and costs.
5G Connectivity: Facilitates rapid data transfer, ensuring seamless order processing and delivery.
Photon Quantum Computing: Enhances computational efficiency for complex demand forecasting and pricing models.

These technologies enable B_N\hat{ }M to produce high-quality products without the need for expensive marketing campaigns or sales teams, as the AI Core directly matches products to consumer needs.

### 3.3 Pre-Paid Orders

The receipt of full payments (p_n\hat{ }m) before production is a critical feature of the Platform. Consumers pay for products upon ordering, providing B_N\hat{ }M with immediate capital to cover production costs. This eliminates the need for manufacturers to secure bank loans, thereby avoiding interest expenses. The real estate crowdfunding example illustrates this mechanism:
Consumers collectively fund a housing project through the Platform, covering all costs (e.g., land acquisition, construction, decoration).
The manufacturer (B_N\hat{ }M) receives these funds upfront, eliminating the need for bank financing.
Without interest costs, advertising, sales, or marketing expenses, the manufacturer can offer houses at 25% to 40% below market prices.

This model extends to other industries, such as clothing, food, and healthcare, where pre-paid orders ensure cost-free production and competitive pricing.

### 4. Consumer Benefits

The elimination of traditional costs translates into significant benefits for consumers (C_N\hat{ }M). By leveraging economies of scale and AI optimization, the Platform delivers products with the best quality and lowest prices globally. Key consumer benefits include:
Cost Savings: Products are priced 25% to 40% lower than market rates due to the absence of fixed costs.
High Quality: AI-driven design and production ensure superior product quality, comparable to industry leaders in each category.
Time Efficiency: The AI Core recommends products based on consumer needs, eliminating the need for research or comparison shopping.
Global Access: The Platform supports a diverse range of products, from necessities (clothing, food, shelter) to services (healthcare, education), accessible to consumers worldwide.

The real estate example highlights these benefits: consumers can purchase high-quality homes at a 25% to 40% discount, achieving immediate investment returns while securing housing.

### 5. Compliance with USPTO Requirements

This description ensures compliance with USPTO requirements:

5.1 35 U.S.C. 112(b)—Indefiniteness

The description presents a clear and operative method in a structured, single-sentence format for key processes, as required. The process flow is organized to delineate each step, from order placement to product delivery, ensuring clarity and specificity. For example:
“Consumers (C_N\hat{ }M) submit orders for products (b_n\hat{ }m) through the AI Core (200), which aggregates demand and assigns production to manufacturers (B_N\hat{ }M) who receive full payments (p_n\hat{ }m) before producing and delivering the products.”

### 5.2 35 U.S.C. 101—Abstract Idea

The invention integrates the abstract idea of facilitating transactions into a practical application through:
Specific Technical Solution: The AI Core employs advanced technologies to optimize production, pricing, and delivery, transforming traditional commerce into a cost-free, consumer-driven model.
Technical Improvement: The elimination of fixed costs (sales, marketing, inventory, advertisement, finance) improves manufacturing efficiency and reduces consumer prices, addressing inefficiencies in traditional retail.
Tangible Benefits: Consumers receive high-quality products at significantly lower prices, and manufacturers operate without financial burdens, ensuring scalability and global impact.

The AI Core and platform tiers (MMPALL, MMPS, MMPSS, MMPM) are not generic computer functions but are specifically designed to eliminate traditional costs and optimize direct manufacturer-consumer interactions.

### 6. Comparison with Prior Art

The MMPALL+S+SS+M platform distinguishes itself from prior art, the MMPALL+S+SS+M platform:
Directly connects manufacturers to consumers, bypassing intermediaries.
Eliminates fixed costs by securing full payments before production.
Uses AI to optimize production based on exact demand, rather than market estimates.

This results in a more efficient, cost-effective, and scalable model, addressing inefficiencies not covered by prior art's system.

### 7. Scalability and Global Impact

The Platform is designed to scale to a global consumer base, potentially serving 8.3 billion people. As the number of consumers (N) and product types (M) increase, the AI Core's ability to aggregate demand and optimize production ensures that B_N\hat{ }M maintain their cost advantage. This scalability is supported by:
Global Connectivity: 5G and cloud computing enable real-time coordination across regions.
AI Optimization: Machine learning and big data analytics adapt to diverse consumer needs.
Tiered Structure: The Platform's tiers (MMPALL, MMPS, MMPSS, MMPM) accommodate manufacturers of all sizes, from large corporations to micro-enterprises.

The real estate crowdfunding example demonstrates scalability: a single project can involve thousands of consumers, with the potential to expand to millions globally.

### 8. Security and Authentication

To ensure secure transactions, the Platform employs cryptographic protocols. Key security features include:
Digital Signatures: Manufacturers and consumers are authenticated to prevent fraud.
Encryption: Payment and order data are encrypted to ensure privacy and non-repudiation.
Secure Database: The AI Core maintains a tamper-proof record of transactions, accessible only to authorized parties.

These measures ensure trust and reliability, critical for a platform handling large-scale, pre-paid orders.

### 9. Implementation Example

Consider a clothing industry scenario:
Consumers (C_N\hat{ }M) order 1 million units of a specific apparel item (b_n\hat{ }m) through the AI Core.
The AI Core aggregates demand and assigns production to a manufacturer (B_N\hat{ }M) under MMPALL.
The manufacturer receives full payment (p_n\hat{ }m) upfront, covering all production costs.
The apparel is produced and delivered without incurring sales, marketing, inventory, advertisement, or interest costs.
Consumers receive high-quality apparel at a price 25% lower than market rates, while the manufacturer operates efficiently without financial burdens.

This model applies to other industries, such as electronics, food, and real estate, demonstrating the Platform's versatility.

### 10. Conclusion

The MMPALL+S+SS+M platform revolutionizes commerce by eliminating traditional fixed costs for manufacturers, enabling them to deliver high-quality products at the lowest prices. By leveraging the AI Core to process pre-paid orders and optimize production, the Platform ensures efficiency, scalability, and consumer satisfaction. The real estate crowdfunding example underscores the practical application of this invention, offering consumers significant savings and manufacturers unparalleled competitive advantages. This detailed description complies with USPTO requirements, addressing indefiniteness and abstract idea concerns, and positions the invention as a transformative advancement in modem commerce.

FIG. 4

### DETAILED DESCRIPTION OF THE INVENTION

The present invention, embodied in the MMPALL+S+SS+M platform (hereinafter referred to as “the Platform”), revolutionizes modem commerce by facilitating direct, AI-driven transactions between manufacturers and consumers, eliminating traditional business costs, and providing unparalleled competitive advantages. This detailed description focuses on FIG. 4 of the accompanying drawings, titled “Manufacturers B_N\hat{ }M Belongs to MMPALL+S+SS+M Through AI Core Do Not Have Cost of Sales, Marketing, Inventory, Advertisement, Finance (Interests) Since B_N\hat{ }M Received Ordered Products b_n\hat{ }m and Payments p_n\hat{ }m from Customers C_N\hat{ }M Through AI Core While IB_N\hat{ }M that Do Not Belongs to MMPALL+S+SS+M Through AI Core Do Have Cost of Sales, Marketing, Inventory, Advertisement, Finance (Interests), Thereby B_N\hat{ }M Will Eliminate IB_N\hat{ }M.” This section complies with the requirements of the United States Patent and Trademark Office (USPTO), addressing 35 U.S.C. 112(b) and 35 U.S.C. 101, while providing a clear, specific, and operative method description. The description emphasizes the cost elimination and competitive elimination mechanisms, as supported by Claim 3 of the patent application, and aligns with the hand-drawn schematic provided in FIG. 4.

### 1. Overview of the Invention

The MMPALL+S+SS+M platform redefines commerce by enabling manufacturers (denoted as B_N\hat{ }M) to produce and deliver products (b_n\hat{ }m) directly to consumers (C_N\hat{ }M) through an AI Core, bypassing traditional retail and wholesale intermediaries. The Platform eliminates fixed costs-sales, marketing, inventory, advertisement, and finance (interest) for B_N\hat{ }M by securing full payments (p_n\hat{ }m) from consumers before production. In contrast, non-platform manufacturers (IB_N\hat{ }M) incur these costs, which are passed on to consumers, resulting in higher prices and reduced competitiveness. The AI Core leverages advanced technologies, including big data, cloud computing, machine learning, 5G, and photon quantum computing, to optimize production, pricing, and delivery, ensuring the highest quality products at the lowest prices globally. This cost differential enables B_N\hat{ }M to outcompete and eliminate IB_N\hat{ }M, transforming industries by prioritizing efficiency and consumer value.

FIG. 4 illustrates the competitive dynamics between B_N\hat{ }M and IB_N\hat{ }M, highlighting how the Platform's cost-elimination strategy gives B_N\hat{ }M a decisive advantage. By receiving pre-paid orders through the AI Core, B_N\hat{ }M avoid traditional expenses, while IB_N\hat{ }M's costs inflate product prices, rendering them uncompetitive. This mechanism supports Claim 3, which articulates the Platform's ability to eliminate inefficient enterprises across all industries.

### 2. FIG. 4: System Architecture and Process Flow

FIG. 4 depicts the operational framework of the MMPALL+S+SS+M platform, emphasizing the cost-free operation of B_N\hat{ }M and the cost-burdened operation of IB_N\hat{ }M. The schematic includes labeled components and processes, as follows:

### 2.1 Components of the System

AI Core (200): The central processing hub of the Platform, responsible for receiving consumer orders, aggregating demand, coordinating production, and processing payments. The AI Core employs advanced technologies to optimize product quality, pricing, and delivery schedules.
Manufacturers B_N\hat{ }M (300): Efficient manufacturers registered on the Platform, belonging to one or more tiers: MMPALL (305), MMPS (310), MMPSS (315), or MMPM (320). These tiers accommodate various scales of production, from large-scale manufacturing (MMPALL) to micro-enterprises (MMPM).
Customers C_N\hat{ }M (400): Global consumers who place orders for products (b_n\hat{ }m) and provide payments (p_n\hat{ }m) through the AI Core. The Platform supports a scalable consumer base, potentially encompassing 8.3 billion people.
Products b_n\hat{ }m (405): Goods or services produced by B_N\hat{ }M in response to consumer orders. These products are optimized for superior quality and minimal cost, achieved through AI-driven design and production.
Payments p_n\hat{ }m: Financial transactions from C_N\hat{ }M to B_N\hat{ }M, processed through the AI Core. Payments are received in full before production, eliminating the need for manufacturers to incur debt or maintain inventory.
Manufacturers IB_N\hat{ }M (350): Non-platform manufacturers that do not belong to MMPALL+S+SS+M. These entities incur traditional costs (sales, marketing, inventory, advertisement, finance) and transfer these costs to consumers, resulting in higher prices.
Cost Transfer and Elimination (360, 370): The mechanism by which IB_N\hat{ }M's costs inflate product prices, making them uncompetitive, while B_N\hat{ }M's cost-free operation enables lower prices, leading to the elimination of IB_N\hat{ }M.

### 2.2 Process Flow

The process begins with consumers (C_N\hat{ }M, 400) submitting orders for products (b_n\hat{ }m, 405) through the AI Core (200). The AI Core aggregates demand, determining the exact quantity (N) and type (M) of products required. Manufacturers B_N\hat{ }M (300), registered under MMPALL (305), MMPS (310), MMPSS (315), or MMPM (320), receive these orders along with full payments (p_n\hat{ }m). The AI Core matches orders with appropriate manufacturers based on production capacity and product specifications.

B_N\hat{ }M produce and deliver products without incurring traditional costs:
Sales Costs: Eliminated, as the Platform connects manufacturers directly to consumers.
Marketing Costs: Unnecessary, as the AI Core uses demand data to promote products.
Inventory Costs: Avoided, as production occurs only after orders and payments are received.
Advertisement Costs: Obviated, as AI-driven recommendations match products to consumers.
Finance (Interest) Costs: Eliminated, as full payments cover production costs, negating the need for loans.

In contrast, IB_N\hat{ }M (350) incur these costs, which are transferred to consumers (360) through higher prices for products (b_n\hat{ }m). Consumers ordering from IB_N\hat{ }M pay significantly more due to these costs, making IB_N\hat{ }M uncompetitive. As a result, B_N\hat{ }M dominate the market, eliminating IB_N\hat{ }M (370) due to their cost-free operation and lower pricing.

### 3. Cost Elimination and Competitive Advantage

Claim 3 articulates the Platform's core innovation: the elimination of fixed costs for B_N\hat{ }M, providing them with unparalleled competitive advantages. This section elaborates on how the Platform achieves this cost elimination and leverages it to eliminate IB_N\hat{ }M across industries.

### 3.1 Cost Elimination Mechanism

The Platform's consumer-to-business (C2B) model ensures that production is initiated only after consumers place orders and provide full payments. This pre-paid order system eliminates the need for:
Sales Teams: Direct manufacturer-consumer interactions via the AI Core bypass intermediaries.
Marketing Campaigns: AI-driven demand analysis and product recommendations replace traditional marketing.
Inventory Management: On-demand production eliminates the need for stockpiling goods.
Advertising: The AI Core promotes products based on consumer preferences, negating advertising expenses.
Bank Loans: Full payments from consumers cover production costs, eliminating the need for financing and interest expenses.

This cost-free operation allows B_N\hat{ }M to offer products at prices significantly lower than those of IB_N\hat{ }M, who must account for these expenses in their pricing.

### 3.2 Competitive Elimination of IB_N\hat{ }M

The cost differential between B_N\hat{ }M and IB_N\hat{ }M creates a competitive imbalance. IB_N\hat{ }M's expenses—sales, marketing, inventory, advertisement, and finance—are transferred to consumers, inflating product prices. For example:
A product priced at $100 by B_N\hat{ }M might cost $125-$140 from IB_N\hat{ }M due to their fixed costs.
Consumers, incentivized by lower prices, prefer B_N\hat{ }M, reducing IB_N\hat{ }M's market share.

As demand shifts to B_N\hat{ }M, IB_N\hat{ }M struggle to compete, especially as the Platform scales to serve large consumer bases (N>No). In extreme cases, when N approaches infinity (e.g., 8.3 billion global consumers), IB_N\hat{ }M cannot sustain operations without significant revenue, leading to their elimination from the market.

### 3.3 Real Estate Crowdfunding Example

The patent documents highlight real estate crowdfunding as a practical application of this mechanism:
Consumers (C_N\hat{ }M) collectively fund a housing project through the Platform, covering costs such as land acquisition, construction, and decoration.
The manufacturer (B_N\hat{ }M) receives these funds upfront, eliminating the need for bank loans and associated interest costs.
Without expenses for sales, marketing, inventory, or advertising, B_N\hat{ }M can offer houses at 25% to 40% below market prices.
IB_N\hat{ }M, reliant on traditional financing and marketing, cannot match these prices, as their costs inflate housing prices by 25%-40%.

This example illustrates how B_N\hat{ }M's cost-free operation enables them to dominate the market, rendering IB_N\hat{ }M uncompetitive.

### 4. Consumer Benefits

The Platform's cost-elimination strategy translates into significant benefits for consumers (C_N\hat{ }M):
Lower Prices: Products are priced 25% to 40% below market rates due to the absence of fixed costs.
Superior Quality: AI-driven optimization ensures products meet the highest quality standards in their categories.
Time Efficiency: The AI Core recommends products based on consumer needs, eliminating research and comparison shopping.
Global Accessibility: The Platform supports a wide range of products and services, from necessities (clothing, food, shelter) to specialized services (healthcare, education), accessible worldwide.

The real estate example underscores these benefits: consumers secure high-quality homes at substantial discounts, achieving immediate investment returns while meeting housing needs.

### 5. Compliance with USPTO Requirements

This description ensures compliance with USPTO requirements:

5.1 35 U.S.C. 112(b)—Indefiniteness

The description presents a clear, operative method in a structured format, with each process step articulated in a single sentence where appropriate. The use of trademarks has been avoided, and references to specific brands have been replaced with generic descriptions (e.g., “industry-leading manufacturers”). The process flow is organized to delineate each step, from order placement to competitive elimination, ensuring clarity and specificity. For example:
“Consumers (C_N\hat{ }M) submit orders for products (b_n\hat{ }m) through the AI Core (200), which assigns production to manufacturers (B_N\hat{ }M) who receive full payments (p_n\hat{ }m) before producing and delivering products, while non-platform manufacturers (IB_N\hat{ }M) incur traditional costs that inflate prices, leading to their elimination.”

### 5.2 35 U.S.C. 101—Abstract Idea

The invention integrates the abstract idea of facilitating transactions into a practical application through:
Specific Technical Solution: The AI Core leverages advanced technologies to eliminate costs and optimize production, transforming commerce into a cost-free, consumer-driven model.
Technical Improvement: The elimination of fixed costs improves manufacturing efficiency and reduces consumer prices, addressing inefficiencies in traditional retail.
Tangible Benefits: Consumers receive high-quality products at lower prices, and B_N\hat{ }M gain competitive advantages, ensuring scalability and global impact.

The AI Core and platform tiers are not generic computer functions but are specifically designed to eliminate costs and enable direct manufacturer-consumer interactions.

### 6. Comparison with Prior Art

The MMPALL+S+SS+M platform distinguishes itself from prior art. Key differences include:
Direct Manufacturer-Consumer Transactions: The Platform bypasses intermediaries.
Cost Elimination: B_N\hat{ }M avoid fixed costs through pre-paid orders, a feature not addressed by prior art.
AI Optimization: The AI Core optimizes production based on exact demand.

This results in a more efficient, cost-effective, and scalable model, addressing inefficiencies not covered by prior art. 7. Scalability and Global Impact

The Platform is designed to scale globally, supporting transactions for up to 8.3 billion consumers. As N and M increase, the AI Core's ability to aggregate demand and optimize production ensures B_N\hat{ }M's cost advantage grows. Key scalability features include:
Global Connectivity: 5G and cloud computing enable real-time coordination across regions.
AI Adaptability: Machine learning adapts to diverse consumer needs and market conditions.
Tiered Structure: The Platform's tiers accommodate manufacturers of all sizes, ensuring inclusivity.

The real estate crowdfunding example demonstrates scalability: projects can involve thousands to millions of consumers, with potential global expansion.

### 8. Security and Authentication

The Platform employs cryptographic protocols, to ensure secure transactions:
Digital Signatures: Authenticate manufacturers and consumers to prevent fraud.
Encryption: Protect payment and order data, ensuring privacy and non-repudiation.
Secure Database: The AI Core maintains a tamper-proof transaction record.

These measures ensure trust and reliability, critical for handling large-scale, pre-paid orders.

### 9. Implementation Example

Consider an electronics industry scenario:
Consumers (C_N\hat{ }M) order 1 million smartphones (b_n\hat{ }m) through the AI Core.
The AI Core assigns production to a B_N\hat{ }M under MMPALL, who receives full payment (p_n\hat{ }m) upfront.
The smartphones are produced without sales, marketing, inventory, advertisement, or interest costs.
Consumers receive high-quality smartphones at 25% below market prices.
IB_N\hat{ }M, incurring traditional costs, charge 25%-40% more, losing market share to B_N\hat{ }M.

This model applies to other industries, demonstrating the Platform's versatility and competitive impact.

### 10. Conclusion

The MMPALL+S+SS+M platform revolutionizes commerce by eliminating fixed costs for B_N\hat{ }M, enabling them to deliver high-quality products at the lowest prices. By leveraging the AI Core to process pre-paid orders and optimize production, the Platform outcompetes IB_N\hat{ }M, who are burdened by traditional expenses. The real estate crowdfunding example illustrates this advantage, offering consumers significant savings and B_N\hat{ }M decisive market dominance. This description complies with USPTO requirements, addressing indefiniteness and abstract idea concerns, and positions the invention as a transformative advancement in modern commerce.

FIG. 5

### DETAILED DESCRIPTION OF THE INVENTION

The present invention, embodied in the MMPALL+S+SS+M platform (hereinafter referred to as “the Platform”), introduces a groundbreaking method for facilitating direct, AI-driven transactions between manufacturers and consumers, saving both time and money for consumers while delivering the highest quality products at the lowest prices. This detailed description focuses on FIG. 5 of the accompanying drawings, titled “The Invention Save People's Time and Money.” This section complies with the requirements of the United States Patent and Trademark Office (USPTO), addressing 35 U.S.C. 112(b) and 35 U.S.C. 101, while providing a clear, specific, and operative method description. The description emphasizes the time and cost savings for consumers, as supported by Claim 3 of the patent application, and aligns with the hand-drawn schematic provided in FIG. 5.

### 1. Overview of the Invention

The MMPALL+S+SS+M platform transforms commerce by enabling manufacturers (denoted as B_N\hat{ }M) to produce and deliver products (b_n\hat{ }m) directly to consumers (C_N\hat{ }M) through an AI Core, bypassing traditional retail layers and associated costs. The Platform leverages advanced technologies, including big data, cloud computing, machine learning, 5G, and photon quantum computing, to recommend and produce products tailored to consumer needs, ensuring the best quality and lowest prices. By eliminating fixed costs (sales, marketing, inventory, advertisement, and finance) and using AI-driven recommendations, the Platform saves consumers significant time and money. Consumers benefit from discounted prices (25%-40% below market rates) and eliminate the need to research or compare products, as the AI Core proactively delivers optimal solutions.

FIG. 5 illustrates how the Platform saves time and money for consumers (C_N\hat{ }M) by delivering AI-recommended, high-quality, low-cost products directly from manufacturers. The schematic highlights the consumer experience, emphasizing the efficiency of AI-driven product recommendations and the cost savings achieved through the Platform's cost-free manufacturing model. This aligns with Claim 3, which articulate the Platform's ability to save money through cost elimination and time through intelligent product recommendations.

### 2. FIG. 5: System Architecture and Process Flow

FIG. 5 depicts the operational framework of the MMPALL+S+SS+M platform, focusing on the consumer experience and the mechanisms that save time and money. The schematic includes labeled components and processes, as follows:

### 2.1 Components of the System

AI Core (200): The central processing hub of the Platform, responsible for receiving consumer orders, aggregating demand, recommending products, coordinating production, and processing payments. The AI Core uses advanced technologies to analyze consumer needs, optimize product quality, and ensure minimal pricing.
Manufacturers B_N\hat{ }M (300): Efficient manufacturers registered on the Platform, belonging to one or more tiers: MMPALL (305), MMPS (310), MMPSS (315), or MMPM (320). These tiers accommodate various scales of production, from large-scale manufacturing (MMPALL) to micro-enterprises (MMPM).
Customers C_N\hat{ }M (400): Global consumers who place orders for products (b_n\hat{ }m) and provide payments (p_n\hat{ }m) through the AI Core. The Platform supports a scalable consumer base, potentially encompassing 8.3 billion people.
Products b_n\hat{ }m (330): Goods or services produced by B_N\hat{ }M in response to consumer orders. These products are characterized by the best quality and lowest prices in their categories, achieved through AI-driven optimization and cost-free production.
Payments p_n\hat{ }m: Financial transactions from C_N\hat{ }M to B_N\hat{ }M, processed through the AI Core. Payments are received in full before production, eliminating the need for manufacturers to incur debt or maintain inventory.
Time and Money Savings (420, 425): The consumer benefits of receiving AI-recommended products without needing to research or compare options, coupled with significant cost savings due to the Platform's cost-free manufacturing model.

### 2.2 Process Flow

The process begins with consumers (C_N\hat{ }M, 400) interacting with the AI Core (200), which uses machine learning and big data analytics to recommend products (b_n\hat{ }m, 330) tailored to their specific needs. These recommendations are based on consumer preferences, historical data, and real-time market analysis, ensuring the best quality and lowest prices. Consumers place orders for these products and provide full payments (p_n\hat{ }m) through the AI Core.

The AI Core aggregates demand, determining the exact quantity (N) and type (M) of products required, and assigns production to manufacturers (B_N\hat{ }M, 300) registered under MMPALL (305), MMPS (310), MMPSS (315), or MMPM (320).

Manufacturers produce and deliver the products directly to consumers, bypassing retail layers. This direct delivery, combined with the absence of fixed costs (sales, marketing, inventory, advertisement, finance), enables B_N\hat{ }M to offer products at prices 25%-40% below market rates.

Consumers save time (420) because the AI Core eliminates the need to research, compare, or select products manually. They save money (425) due to the discounted prices resulting from the Platform's cost-free production model. The entire process is seamless, efficient, and consumer-centric, delivering unparalleled value.

### 3. Time and Money Savings Mechanisms

Claim 3 articulate the Platform's core innovation: saving consumers time and money through AI-driven recommendations and cost-free manufacturing. This section elaborates on these mechanisms, with specific examples from real estate and consumer goods.

### 3.1 Money Savings Through Cost Elimination

The Platform eliminates fixed costs for manufacturers (B_N\hat{ }M), enabling them to offer products at significantly lower prices. These costs include:
Sales Costs: Direct manufacturer-consumer interactions via the AI Core eliminate intermediaries.
Marketing Costs: AI-driven product recommendations replace traditional marketing campaigns.
Inventory Costs: On-demand production avoids the need for stockpiling goods.
Advertisement Costs: The AI Core promotes products based on consumer needs, negating advertising expenses.
Finance (Interest) Costs: Full payments from consumers cover production costs, eliminating the need for bank loans.

This cost-free model results in product prices 25%-40% below market rates. The real estate crowdfunding example illustrates this:
Consumers (C_N\hat{ }M) collectively fund a housing project through the Platform, covering costs such as land, construction, and decoration.
The manufacturer (B_N\hat{ }M) receives these funds upfront, eliminating the need for bank loans and interest costs.
Without expenses for sales, marketing, inventory, or advertising, B_N\hat{ }M offer houses at 25%-40% below market prices.
Consumers achieve an immediate investment return of 25%-40% upon purchasing these properties, as the purchase price is significantly lower than market value.

This model extends to other industries, such as clothing, food, and electronics, where pre-paid orders ensure cost-free production and competitive pricing.

3.2 Time Savings through AI Recommendations

The AI Core saves consumers time by proactively recommending products that meet their specific needs, eliminating the need for research or comparison. The AI Core analyzes:
Consumer Preferences: Historical purchase data and stated needs.
Market Trends: Real-time analysis of product quality, pricing, and availability.
Lifecycle Needs: Products tailored to different stages of life, from infancy to elderly care.

For example:
New Mother Scenario: A new mother lacking childcare experience needs formula for her baby. The AI Core recommends high-quality, cost-effective formula (e.g., products comparable to industry leaders in quality and price). The mother receives the recommendation instantly, without spending time researching or comparing options.
White-Collar Woman Scenario: A professional woman needs clothing for work, leisure, and home. The AI Core recommends and coordinates the production of tailored clothing, leveraging advanced manufacturing technology. The woman receives her wardrobe seamlessly, saving hours of shopping and decision-making.

These examples demonstrate how the AI Core streamlines the consumer experience, delivering optimal products without requiring time-intensive effort.

### 4. Consumer Benefits

The Platform's time and money savings translate into significant consumer benefits:
Cost Savings: Products priced 25%-40% below market rates due to cost-free production.
Time Efficiency: AI-driven recommendations eliminate the need for research, comparison, or decision-making.
Superior Quality: AI-optimized production ensures products meet the highest standards in their categories.
Lifecycle Coverage: The Platform supports a wide range of products and services, from necessities (clothing, food, shelter) to specialized needs (healthcare, education), tailored to all stages of life.
Investment Returns: In real estate, consumers achieve immediate returns of 25%-40% due to discounted purchase prices.

These benefits make the Platform a consumer-centric solution, enhancing quality of life while reducing financial and temporal burdens.

### 5. Compliance with USPTO Requirements

This description ensures compliance with USPTO requirements:

5.1 35 U.S.C. 112(b)—Indefiniteness

The description presents a clear, operative method in a structured format, with each process step articulated concisely. Trademark references (e.g., Feihe, Junlebao) have been replaced with generic descriptions (e.g., “high-quality, cost-effective formula comparable to industry leaders”). The process flow is organized to delineate each step, from AI recommendation to product delivery, ensuring clarity and specificity.

For example:
“Consumers (C_N\hat{ }M) receive AI-recommended products (b_n\hat{ }m) from the AI Core (200), place orders with full payments (p_n\hat{ }m), and receive high-quality, low-cost products directly from manufacturers (B_N\hat{ }M), saving time and money.”

### 5.2 35 U.S.C. 101—Abstract Idea

The invention integrates the abstract idea of facilitating transactions into a practical application through:
Specific Technical Solution: The AI Core leverages advanced technologies to recommend products, optimize production, and eliminate costs, transforming commerce into a consumer-driven model.
Technical Improvement: The elimination of fixed costs and time-intensive research improves efficiency and reduces consumer burdens, addressing inefficiencies in traditional retail.
Tangible Benefits: Consumers save money (25%-40% discounts) and time (no research needed), while manufacturers operate efficiently, ensuring scalability and global impact.

The AI Core and platform tiers are not generic computer functions but are specifically designed to save time and money through tailored recommendations and cost-free production.

### 6. Comparison with Prior Art

The MMPALL+S+SS+M platform distinguishes itself from prior art. Key differences include:
Direct Manufacturer-Consumer Transactions: The Platform bypasses intermediaries.
Time and Money Savings: The AI Core's recommendations and cost-free production save consumers time and money, features not addressed by Pric.
AI Optimization: The Platform optimizes production and recommendations based on exact consumer needs.

This results in a more efficient, consumer-centric, and scalable model, addressing inefficiencies not covered by prior art.

### 7. Scalability and Global Impact

The Platform is designed to scale globally, supporting transactions for up to 8.3 billion consumers. As the number of consumers (N) and product types (M) increase, the AI Core's ability to recommend and optimize products ensures continued time and cost savings. Key scalability features include:
Global Connectivity: 5G and cloud computing enable real-time coordination across regions.
AI Adaptability: Machine learning adapts to diverse consumer needs and market conditions.
Tiered Structure: The Platform's tiers accommodate manufacturers of all sizes, ensuring inclusivity.

The real estate crowdfunding example demonstrates scalability: projects can involve thousands to millions of consumers, with potential global expansion.

### 8. Security and Authentication

The Platform employs cryptographic protocols, to ensure secure transactions:
Digital Signatures: Authenticate consumers and manufacturers to prevent fraud.
Encryption: Protect payment and order data, ensuring privacy and non-repudiation.
Secure Database: The AI Core maintains a tamper-proof transaction record.

These measures ensure trust and reliability, critical for handling large-scale, pre-paid orders.

### 9. Implementation Examples

### 9.1 Real Estate Crowdfunding

Consumers (C_N\hat{ }M) fund a housing project through the AI Core, covering all costs upfront.
The AI Core assigns production to a B_N\hat{ }M under MMPALL, who delivers houses without sales, marketing, inventory, advertisement, or interest costs.
Consumers purchase homes at 25%-40% below market prices, achieving immediate investment returns.

### 9.2 Consumer Goods (Formula)

A new mother needs formula for her baby. The AI Core recommends a high-quality, cost-effective option based on the baby's needs.
The mother places an order and pays through the AI Core, receiving the formula directly from a B_N\hat{ }M.
The process saves her time (no research needed) and money (lower price due to cost-free production).

### 9.3 Clothing

A professional woman needs clothing for various contexts. The AI Core recommends tailored options and coordinates production.
The woman receives her wardrobe directly, saving time and money while enjoying high-quality, low-cost clothing.

These examples demonstrate the Platform's versatility across industries.

### 10. Conclusion

The MMPALL+S+SS+M platform revolutionizes commerce by saving consumers time and money through AI-driven product recommendations and cost-free manufacturing. By delivering high-quality, low-cost products directly from manufacturers, the Platform eliminates the need for research and offers significant discounts (25%-40% below market prices). The real estate crowdfunding example highlights the financial benefits, while consumer goods scenarios demonstrate time savings. This description complies with USPTO requirements, addressing indefiniteness and abstract idea concerns, and positions the invention as a transformative advancement in modern commerce.

FIG. 6

### DETAILED DESCRIPTION OF THE INVENTION

The present invention, embodied in the MMPALL+S+SS+M platform (hereinafter referred to as “the Platform”), fundamentally transforms the global manufacturing industry into a service-oriented paradigm, leveraging artificial intelligence (AI) to eliminate inefficiencies, reduce costs, and redefine economic and societal frameworks. This detailed description focuses on FIG. 6 of the accompanying drawings, titled “The Invention Enable the Entire Manufacturing Industry to Become the Service Industry, Create a Wave and Eliminate Manufacturers that Do Not Belong to the AI Core Platform Thereby Inefficient and Ineffective.” This section complies with the requirements of the United States Patent and Trademark Office (USPTO), addressing 35 U.S.C. 112(b) and 35 U.S.C. 101, while providing a clear, specific, and operative method description. The description emphasizes the revolutionary transformation of industries, as supported by Claims 3 and 4 of the patent application, and aligns with the drawn schematic provided in FIG. 6.

### 1. Overview of the Invention

The MMPALL+S+SS+M platform redefines the manufacturing industry by integrating AI-driven design, production, and delivery processes to transform traditional manufacturing into a service industry. By leveraging the AI Core, the Platform enables manufacturers (B_N\hat{ }M) to produce products (b_n\hat{ }m) based on precise consumer demand, eliminating fixed costs such as sales, marketing, inventory, advertisement, and finance (interest). This cost-free, demand-driven model ensures the highest quality products at the lowest prices, saving consumers (C_N\hat{ }M) time and money. The Platform's transformative impact extends beyond cost elimination, merging traditional first (agriculture), second (manufacturing), and third (services) industries into a unified, AI-driven service paradigm. This fusion disrupts conventional economic theories, reshapes modern commercial rules, and redefines human civilization's progress, creating a wave comparable to “Smart Industry 5.0.”

FIG. 6 illustrates how the AI Core transforms manufacturing into a service industry, eliminates inefficient manufacturers (IB_N\hat{ }M), and redefines economic and societal structures. The schematic highlights the integration of production and service delivery, the elimination of random production and consumption, and the broader implications for modern economics and human behavior. This aligns with Claims 3 and 4, which articulate the Platform's revolutionary impact on industries, economics, and civilization.

### 2. FIG. 6: System Architecture and Process Flow

FIG. 6 depicts the operational framework of the MMPALL+S+SS+M platform, emphasizing the transformation of manufacturing into a service industry and the elimination of inefficient manufacturers. The schematic includes labeled components and processes, as follows:

### 2.1 Components of the System

AI Core (200): The central processing hub of the Platform, responsible for analyzing consumer demand, recommending products, coordinating AI-driven production, and processing payments. The AI Core leverages advanced technologies (big data, machine learning, cloud computing, 5G, photon quantum computing) to optimize production and service delivery.
Manufacturers B_N\hat{ }M (300): Efficient manufacturers registered on the Platform, belonging to one or more tiers: MMPALL (305), MMPS (310), MMPSS (315), or MMPM (320). These tiers accommodate various scales of production, from large-scale manufacturing to micro-enterprises.
Customers C_N\hat{ }M (400): Global consumers who place orders for products (b_n\hat{ }m) and provide payments (p_n\hat{ }m) through the AI Core. The Platform supports a scalable consumer base, potentially encompassing 8.3 billion people.
Products b_n\hat{ }m: Goods or services produced by B_N\hat{ }M in response to consumer demand. These products are optimized for superior quality and minimal cost, delivered directly to consumers without retail layers.
Payments p_n\hat{ }m: Financial transactions from C_N\hat{ }M to B_N\hat{ }M, processed through the AI Core. Full payments are received before production, eliminating the need for manufacturers to incur debt or maintain inventory.
Industry Transformation (230): The merger of manufacturing and service industries into a unified, AI-driven service paradigm, eliminating traditional industry distinctions.
Cost Elimination (235): The absence of fixed costs (sales, marketing, inventory, advertisement, finance) for B_N\hat{ }M, enabling competitive pricing and market dominance.
Economic and Societal Impact (240, 245, 250): The redefinition of modem economic theories, human behavior, and civilization progress through the Platform's transformative model.

### 2.2 Process Flow

The process begins with consumers (C_N\hat{ }M, 400) submitting orders for products (b_n\hat{ }m) and payments (p_n\hat{ }m) through the AI Core (200). The AI Core analyzes consumer needs using big data and machine learning, recommending products tailored to individual preferences and lifecycle stages. It aggregates demand, determining the exact quantity (N) and type (M) of products required, and assigns production to manufacturers (B_N\hat{ }M, 300) registered under MMPALL (305), MMPS (310), MMPSS (315), or MMPM (320).
B_N\hat{ }M produce products using AI-driven design and manufacturing processes, ensuring the highest quality and lowest cost. The AI Core coordinates service-oriented delivery, such as direct shipping to consumers, eliminating retail layers and random production. This process incurs no fixed costs:
Sales Costs: Eliminated through direct manufacturer-consumer interactions.
Marketing Costs: Replaced by AI-driven product recommendations.
Inventory Costs: Avoided through on-demand production.
Advertisement Costs: Obviated by AI-based demand matching.
Finance (Interest) Costs: Eliminated, as full payments cover production costs.

The resulting products are delivered to consumers at prices 25%-40% below market rates, saving time and money. Inefficient manufacturers (IB_N\hat{ }M), who incur these costs and rely on traditional retail models, cannot compete with B_N\hat{ }M's pricing and efficiency, leading to their elimination. The Platform's AI-driven model transforms manufacturing into a service industry (230), redefines commercial rules (235), reshapes economic theories (240), alters consumer behavior (245), and advances human civilization (250).

### 3. Transformation of Manufacturing into a Service Industry

Claim 3 articulates the Platform's core innovation: transforming the manufacturing industry into a service industry through AI-driven processes. This section elaborates on this transformation, its applicability across industries, and its revolutionary implications.

### 3.1 AI-Driven Manufacturing as a Service

The Platform uses the AI Core to integrate design, production, and delivery into a seamless, consumer-centric service model. Key features include:
AI-Driven Design: The AI Core analyzes consumer preferences and market trends to design products tailored to specific needs, eliminating wasteful production.
On-Demand Production: Manufacturing occurs only after orders and payments are received, ensuring no random production or overstock.
Service-Oriented Delivery: Products are delivered directly to consumers, with AI coordinating logistics, resembling a service industry model.

This approach transforms traditional manufacturing (second industry) into a service-oriented paradigm, blurring distinctions between the first (agriculture), second, and third (services) industries. For example, in the fashion industry:
Consumers specify clothing preferences through the AI Core.
The AI Core designs and assigns production to a B_N\hat{ }M, who manufactures the clothing on demand.
The clothing is delivered directly, with no retail layer, resembling a personalized service.

This model applies to all industries, including heavy industries (e.g., automotive, machinery) and light industries (e.g., electronics, food), as the AI Core's flexibility supports diverse production needs.

### 3.2 Elimination of Inefficient Manufacturers

Claim 4 highlights the Platform's ability to eliminate inefficient manufacturers (IB_N\hat{ }M) that do not belong to the AI Core ecosystem. IB_N\hat{ }M incur fixed costs (sales, marketing, inventory, advertisement, finance), which inflate product prices by 25%-40%. In contrast, B_N\hat{ }M operate without these costs, offering superior quality and pricing. This competitive disparity ensures:
Market Dominance: Consumers prefer B_N\hat{ }M's lower-priced, high-quality products.
Elimination of IB_N\hat{ }M: As demand shifts to B_N\hat{ }M, IB_N\hat{ }M lose market share and cannot sustain operations, especially as the Platform scales to serve large consumer bases (N>No).

The real estate crowdfunding example illustrates this:
Consumers fund a housing project through the AI Core, covering all costs upfront.
B_N\hat{ }M deliver houses at 25%-40% below market prices, with no sales, marketing, or financing costs.
IB_N\hat{ }M, reliant on traditional models, cannot match these prices, losing competitiveness and facing elimination.

### 3.3 Industry Fusion and Redefinition

The Platform's AI-driven model eliminates the statistical and conceptual distinctions between traditional industries. By integrating production (second industry) with consumer-driven services (third industry) and sustainable resource use (first industry), the Platform creates a unified industry paradigm. This fusion:
Redefines Economic Metrics: Traditional GDP categorizations (primary, secondary, tertiary) become obsolete, as the Platform's model prioritizes efficiency and consumer value.
Supports Sustainability: On-demand production reduces waste, aligning with low-carbon initiatives and global climate goals.
Applies Universally: The model is scalable across all sectors, from fashion to heavy machinery, ensuring broad impact.

### 4. Creation of a Revolutionary Wave

Claim 4 describes the Platform as creating a wave surpassing the first through fourth industrial revolutions, reshaping commerce, economics, and civilization. This section elaborates on this wave and its implications.

### 4.1 Smart Industry 5.0 and Beyond

The Platform's integration of AI, Industry 4.0, and consumer-driven production aligns with “Smart Industry 5.0,” characterized by:
Human-Centric Technology: AI prioritizes consumer needs, delivering personalized products and services.
Sustainability: On-demand production minimizes waste and resource consumption.
Digital Integration: The AI Core enables “Industrial Internet” and “Digital Industrialization,” connecting manufacturers, consumers, and logistics in real-time.

This wave extends to supply-side structural reform, consumer upgrading, and dual circulation (domestic and international markets), allowing markets to allocate resources efficiently.

### 4.2 Economic and Societal Transformation

The Platform redefines modern economic theories by:
Challenging Microeconomics: The elimination of fixed costs and on-demand production disrupt traditional cost structures and pricing models.
Reshaping Macroeconomics: The fusion of industries and global scalability redefine GDP metrics and economic growth models.
Altering Consumer Behavior: Consumers save time and money, shifting from research-heavy purchasing to AI-guided consumption.

These changes advance human civilization by promoting efficiency, sustainability, and equitable access to high-quality products and services.

### 5. Consumer Benefits

The Platform delivers significant benefits to consumers (C_N\hat{ }M):
Cost Savings: Products priced 25%-40% below market rates due to cost-free production.
Time Efficiency: AI-driven recommendations eliminate research and comparison time.
Superior Quality: AI-optimized production ensures the highest standards.
Sustainability: On-demand production reduces environmental impact.
Global Accessibility: The Platform supports diverse products and services, from necessities to specialized needs, accessible worldwide.

### 6. Compliance with USPTO Requirements

This description ensures compliance with USPTO requirements:

6.1 35 U.S.C. 112(b)—Indefiniteness

The description presents a clear, operative method in a structured format, with each process step articulated concisely. Trademark references have been avoided, and generic descriptions are used (e.g., “high-quality products” instead of specific brands). The process flow is organized to delineate each step, ensuring clarity and specificity. For example:
“Consumers (C_N\hat{ }M) submit orders and payments (p_n\hat{ }m) through the AI Core (200), which coordinates AI-driven production and service delivery by B_N\hat{ }M, transforming manufacturing into a service industry without fixed costs.”

### 6.2 35 U.S.C. 101—Abstract Idea

The invention integrates the abstract idea of facilitating transactions into a practical application through:
Specific Technical Solution: The AI Core leverages advanced technologies to transform manufacturing into a service industry, eliminating costs and inefficiencies.
Technical Improvement: The fusion of industries and elimination of random production improve efficiency and sustainability.
Tangible Benefits: Consumers save time and money, manufacturers gain competitive advantages, and economies are reshaped, ensuring scalability and global impact.

The AI Core and platform tiers are not generic computer functions but are specifically designed to redefine industries and economic models.

### 7. Comparison with Prior Art

The MMPALL+S+SS+M platform distinguishes itself from prior art. Key differences include:
Industry Transformation: The Platform merges manufacturing and services.
Cost and Efficiency: The AI Core eliminates fixed costs and random production, features not addressed by prior art.
Economic Impact: The Platform redefines economic theories and civilization progress, extending beyond prior art's scope.

This results in a more transformative, scalable, and sustainable model.

### 8. Scalability and Global Impact

The Platform is designed to scale globally, supporting up to 8.3 billion consumers. As N and M increase, the AI Core's ability to optimize production and delivery ensures continued efficiency. Key scalability features include:
Global Connectivity: 5G and cloud computing enable real-time coordination.
AI Adaptability: Machine learning supports diverse consumer needs.
Inclusive Tiers: The Platform accommodates manufacturers of all sizes.

The real estate crowdfunding example demonstrates scalability, with potential to expand globally across industries.

### 9. Security and Authentication

The Platform employs cryptographic protocols, to ensure secure transactions:
Digital Signatures: Authenticate consumers and manufacturers.
Encryption: Protect payment and order data.
Secure Database: Maintain tamper-proof transaction records.

These measures ensure trust and reliability for large-scale, pre-paid orders.

### 10. Implementation Example

Consider a fashion industry scenario:
Consumers (C_N\hat{ }M) specify clothing preferences through the AI Core.
The AI Core designs tailored clothing and assigns production to a B_N\hat{ }M under MMPM.
The clothing is produced and delivered directly, with no sales, marketing, inventory, advertisement, or finance costs.
Consumers receive high-quality clothing at 25%-40% below market prices, saving time and money.
IB_N\hat{ }M, incurring traditional costs, cannot compete, facing elimination.

This model applies to heavy industries (e.g., automotive) and other sectors, demonstrating universal applicability.

### 11. Conclusion

The MMPALL+S+SS+M platform revolutionizes commerce by transforming manufacturing into a service industry, eliminating fixed costs, and redefining economic and societal frameworks. By leveraging the AI Core, the Platform delivers high-quality, low-cost products, saves consumer time and money, and eliminates inefficient manufacturers. This transformative wave redefines modern commerce, economics, and human civilization, aligning with Smart Industry 5.0 and sustainability goals. This description complies with USPTO requirements, addressing indefiniteness and abstract idea concerns, and positions the invention as a landmark advancement in global commerce.

1. A method implemented on an intelligent, AI-powered digital commercial governance platform for redefining and restructuring foundational economic theory, commercial coordination, and production-consumption interaction, the method comprising:
a rule transformation subsystem comprising platform-based engines configured to overturn, redefine, reshape, change, and replace legacy commercial rules, said engines executing logic-based interventions on cost structures, supply-demand models, and value exchange principles across microeconomic and macroeconomic domains;
a predictive AI module trained to simulate commercial behavior, wherein the module dynamically alters, replaces, overthrows, redefines, and reshapes modern economic assumptions in real-time, including production scaling, consumer decision pathways, and price formation logic;
a distributed coordination infrastructure labeled MMPALL+S+SS+M, integrating:
an algorithmic macro-micro platform (MMPALL) for synthesizing macroeconomic and microeconomic models with live behavioral inputs;
a smart scheduling engine (S) for coordinating supply timelines with consumption forecasting, thereby eliminating random overproduction and underconsumption;
a subsystem (SS) enabling real-time supply reallocation; a modular manufacturer network (M) configured for decentralized adaptive output;
a structural cost-elimination mechanism configured to remove traditional fixed commercial costs, including advertising, retail markup, and bank interest, replacing them with digital feedback pricing and AI-orchestrated producer-to-consumer delivery via non-retail architecture;
a behavior modeling and legal logic enforcement engine that maps commercial activity to updated economic theory, wherein commercial outputs are regulated via feedback loops and constitutional market reforms embedded in platform governance layers;
a simulation framework operating under theoretical convergence limits N→∞ and M→∞, where N denotes the global set of consumer interactions and M represents distributed manufacturing units, the framework being configured to optimize platform throughput for economic and ecological equilibrium;
a sustainable optimization core configured to regulate carbon intensity, resource consumption, and transactional waste, wherein the platform enables high-efficiency, low-carbon exchange at planetary scale across all industrial sectors.

2. (canceled)

3. (canceled)

4. The method of claim 1, wherein the rule transformation subsystem comprises a blockchain-anchored rules ledger for auditable updates of commercial laws and pricing logic.

5. The method of claim 1, wherein the AI module further includes reinforcement learning trained on global consumer behavioral datasets across diverse cultural and geographic sectors.

6. The method of claim 1, wherein the macro-micro platform (MMPALL) is configured to adjust taxation impact simulations using live economic transactions at municipal, provincial, and national levels.

7. The method of claim 1, wherein the smart scheduling engine (S) synchronizes with distributed energy grids to optimize production timing based on carbon-intensity thresholds.

8. The method of claim 1, wherein the supply subsystem (SS) allocates production dynamically among at least 1,000 decentralized manufacturer nodes using latency-weighted demand clustering.

9. The method of claim 1, wherein the platform removes advertising costs by replacing them with AI-personalized demand visualization modules delivered through peer-based digital trust scores.

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (not entered)

22. (not entered)

23. (not entered)

24. (not entered)

25. (not entered)

26. (not entered)

27. (not entered)

28. (not entered)

29. (not entered)

30. (not entered)

31. (not entered)

32. (not entered)

33. (not entered)

34. A method implemented on an intelligent, AI-powered digital commercial governance platform for redefining and restructuring commercial cost structures and producer-consumer delivery pathways, the method comprising:
a structural cost-elimination mechanism configured to:
a. remove traditional fixed commercial costs including advertising expenses, retail markups, and bank interest costs; and
b. replace said costs with digital feedback pricing that adjusts in real-time based on live supply-demand telemetry;
an AI-orchestrated producer-to-consumer delivery subsystem that operates via a non-retail architecture, wherein products are delivered directly from manufacturers to consumers without intermediating retail layers;
a behavior modeling engine that applies a multi-agent reinforcement learning framework to simulate and alter consumer decision pathways and producer pricing behavior in real time, said engine being trained on global consumer behavioral datasets across diverse cultural and geographic sectors;
a legal logic enforcement engine that automatically executes platform-defined commercial compliance protocols, ensuring that all commercial transactions conform to dynamically updated economic rules without human intervention, wherein said engine maintains a tamper-evident, cryptographically signed log of all commercial rule changes;
wherein the platform enables elimination of random overproduction and underconsumption by synchronizing production initiation only upon receipt of verified consumer demand and full payment.

35. A method implemented on an intelligent, AI-powered digital commercial governance platform for optimizing economic and ecological equilibrium through a scalable simulation framework, the method comprising:
a simulation framework operating under theoretical convergence limits N→∞ and M→∞, where N denotes a global set of consumer interactions and M denotes distributed manufacturing units, the framework being configured to optimize platform throughput for economic and ecological equilibrium by executing iterative optimization cycles that recursively adjust production parameters based on deviation metrics between predicted and actual consumption across N consumer interactions and M manufacturing units;
a sustainable optimization core configured to:
a. regulate carbon intensity, resource consumption, and transactional waste;
b. enable high-efficiency, low-carbon exchange at planetary scale across all industrial sectors;
a distributed coordination infrastructure comprising:
a. an algorithmic macro-micro platform (MMPALL) for synthesizing macroeconomic and microeconomic models with live behavioral inputs;
b. a smart scheduling engine (S) for coordinating supply timelines with consumption forecasting, thereby eliminating random overproduction and underconsumption;
c. a real-time supply reallocation subsystem (SS); and
d. a modular manufacturer network (M) configured for decentralized adaptive output;
wherein the simulation framework further implements a distributed consensus mechanism among the M manufacturing units to collectively determine optimal production volumes without central coordination, and wherein the sustainable optimization core comprises a carbon intensity monitoring module that tracks emissions per unit of production and throttles production when carbon intensity exceeds a platform-defined threshold.

36. The method of claim 34, wherein the digital feedback pricing engine adjusts prices in real time based on live supply-demand telemetry, eliminating fixed markup structures.

37. The method of claim 34, wherein the behavior modeling engine comprises a recursive AI simulation module trained on global consumer behavioral datasets and configured to predict and modify collective consumption patterns across geographic regions.

38. The method of claim 34, wherein the legal logic enforcement engine maintains a tamper-evident log of all commercial rule changes, each rule change being cryptographically signed and timestamped for auditability.

39. The method of claim 34, wherein the platform further includes a producer incentive alignment subsystem that replaces profit-maximization logic with sustainability-optimization logic enforced through smart contract-based reward mechanisms.

40. The method of claim 34, wherein the AI-orchestrated producer-to-consumer delivery comprises a real-time routing optimization engine that minimizes both delivery latency and carbon footprint through multi-objective path planning.

41. The method of claim 34, wherein the platform synchronizes with distributed energy grids to optimize production timing based on carbon-intensity thresholds, thereby reducing emissions associated with manufacturing.

42. The method of claim 35, wherein the simulation framework implements a distributed consensus mechanism among the M manufacturing units to collectively determine optimal production volumes without central coordination.

43. The method of claim 35, wherein the sustainable optimization core comprises a carbon intensity monitoring module that tracks emissions per unit of production across all industrial sectors and throttles production when carbon intensity exceeds a platform-defined threshold.

44. The method of claim 35, wherein the real-time supply reallocation subsystem (SS) applies a latency-weighted demand clustering algorithm to dynamically reassign production orders among the M manufacturing units based on geographic proximity to demand nodes.

45. The method of claim 35, wherein the smart scheduling engine (S) further comprises a consumption entropy calculator that continuously measures variance between predicted and actual demand across N consumer interactions and uses said entropy measurements to update consumption forecasting models in real time.

46. The method of claim 35, wherein the platform further includes a real-time supply-demand telemetry dashboard continuously adjusting manufacturing output to maintain equilibrium and prevent overaccumulation of goods, said dashboard being integrated with the sustainable optimization core.
